(19) United States
(12) Patent Application Publication
(10) Pub. No.: US 2025/0110492 A1
(43) Pub. Date: Apr. 3, 2025

(54) BUILDING MANAGEMENT SYSTEM WITH AUTOMATED EQUIPMENT TESTING AND COMMISSIONING

(71) Applicant: Tyco Fire & Security GmbH, Neuhausen am Rheinfall (CH)

(72) Inventors: Tushar Murlidhar Phadtare, Indapur (IN); Ramesh Chandrakant Chatmutge, Shivane (IN); Madhav Kailas Puri, Sengaon (IN); Neha Santosh Sawant, Pimpri (IN)

(73) Assignee: Tyco Fire & Security GmbH, Neuhausen am Rheinfall (CH)

(21) Appl. No.: 18/900,541

(22) Filed: Sep. 27, 2024

(30) Foreign Application Priority Data
Sep. 29, 2023 (IN) 202341065667

(51) Int. Cl. G05B 23/02; G05B 13/02

(52) U.S. Cl. CPC G05B 23/024; G05B 13/0255

(57) ABSTRACT

A Building Management System (BMS) can include one or more memory devices that can store instructions thereon that, when executed by one or more processors, cause the one or more processors to receive a selection of a plurality of parameters associated with one or more pieces of building equipment of a building, identify an evaluation to test a performance of the one or more pieces of building equipment, determine a routine to perform the evaluation, retrieve a plurality of control parameters associated with a plurality of elements of the routine, and transmit control signals to the one or more pieces of building equipment to execute the routine.

### CROSS-REFERENCE TO RELATED PATENT APPLICATIONS

This application claims the benefit of and priority to Indian Provisional Patent Application No. 202341065667, filed Sep. 29, 2023, the entirety of which is incorporated by reference herein.

### BACKGROUND

A Building Management System (BMS) or Building Automation System (BAS) is, in general, a system of devices configured to control, monitor, and/or manage equipment in or around a building or building area. A BMS or BAS can include, for example, a HVAC system, a security system, a lighting system, a fire alerting system, any other system that is capable of managing building functions or devices, or any combination thereof. The terms BMS and BAS are used synonymously throughout the present disclosure.

A BAS may be controllable from a localized and/or an onsite premise. For example, a BAS may be controllable by an admin within a building. The admin may control the BAS using a computing device (e.g., a desktop computer).

### SUMMARY

At least one embodiment relates to a building management system (BMS). The BMS can include one or more memory devices. The one or more memory devices can store instructions. The instructions can, when executed by one or more processors, cause the one or more processors to receive, via a user interface, a selection of a plurality of parameters associated with building equipment of a building. The plurality of parameters can correspond to one or more features of the building equipment. The instructions can cause the one or more processors to identify, based on the plurality of parameters, an evaluation to test a performance of the building equipment with respect to the one or more features. The instructions can cause the one or more processors to determine, responsive to identification of the evaluation, a routine to perform the evaluation. The routine can include a plurality of actions that correspond to the evaluation. The instructions can cause the one or more processors to retrieve, from a database, a plurality of control parameters configured to cause the building equipment to perform the plurality of actions. The instructions can cause the one or more processors to transmit, to the building equipment, control signals to cause the building equipment to execute the routine by adjusting values for the plurality of control parameters.

In some embodiments, a first control parameter of the plurality of control parameters can include a status parameter for the building equipment. A second control parameter of the plurality of control parameters can include a building parameter controllable by the building equipment.

In some embodiments, transmitting the control signals to execute the routine can include adjusting a building parameter from a first value to a second value to trigger a response from the building equipment, monitoring the response of the building equipment, and evaluating, based on the response of the building equipment, the performance of the building equipment with respect to the one or more features.

In some embodiments, the instructions can cause the one or more processors to update, responsive to completion of the evaluation, the user interface to include an indication of the performance of the building equipment. The indication of the performance of the building equipment can include a first string to indicate the evaluation that was performed and a second string to explain the performance of the building equipment.

In some embodiments, identifying the evaluation can include selecting the evaluation from a plurality of evaluations capable of testing the performance of the building equipment with respect to the one or more features.

In some embodiments, selecting the evaluation from the plurality of evaluations can include determining, based on the plurality of parameters, one or more aspects of the evaluation that correlate to the one or more features of the building equipment, and selecting the evaluation from the plurality of evaluations responsive to determination of the one or more aspects.

In some embodiments, determining the routine to perform the evaluation can include selecting the routine from a plurality of routines capable of generating performance data sufficient to perform the evaluation.

In some embodiments, selecting the routine from the plurality of routines can include determining that the plurality of actions correlate to one or more aspects of the evaluation, and selecting the routine from the plurality of routines responsive to determination of the correlation between the plurality of actions and the one or more aspects.

At least one embodiment relates to a method. The method can include receiving, by one or more processing circuits, via a user interface, a selection of a plurality of parameters associated with building equipment of a building. The plurality of parameters can correspond to one or more features of the building equipment. The method can include identifying, by the one or more processing circuits, based on the plurality of parameters, an evaluation to test a performance of the building equipment with respect to the one or more features. The method can include determining, by the one or more processing circuits, responsive to identification of the evaluation, a routine to perform the evaluation. The routine can include a plurality of actions that correspond to the evaluation. The method can include retrieving, by the one or more processing circuits, from a database, a plurality of control parameters configured to cause the building equipment to perform the plurality of actions. The method can include transmitting, by the one or more processing circuits, to the building equipment, control signals to execute the routine by adjusting values for the plurality of control parameters.

In some embodiments, a first control parameter of the plurality of control parameters can include a status parameter for the building equipment. A second control parameter of the plurality of control parameters can include a building parameter controllable by the building equipment.

In some embodiments, transmitting the control signals to execute the routine can include adjusting, by the one or more processing circuits, a building parameter from a first value to a second value to trigger a response from the building equipment, monitoring, by the one or more processing circuits, the response of the building equipment, and evaluating, by the one or more processing circuits, based on the response of the building equipment, the performance of the building equipment with respect to the one or more features.

In some embodiments, the method can include updating, by the one or more processing circuits, responsive to completion of the evaluation, the user interface to include an indication of the performance of the building equipment. The indication of the performance of the building equipment can include a first string to indicate the evaluation that was performed, and a second string to explain the performance of the building equipment.

In some embodiments, identifying the evaluation can include selecting, by the one or more processing circuits, the evaluation from a plurality of evaluations capable of testing the performance of the building equipment with respect to the one or more features.

In some embodiments, selecting the evaluation from the plurality of evaluations can include determining, by the one or more processing circuits, based on the plurality of parameters, one or more aspects of the evaluation that correlate to the one or more features of the building equipment, and selecting, by the one or more processing circuits, the evaluation from the plurality of evaluations responsive to determination of the one or more aspects.

In some embodiments, determining the routine to perform the evaluation can include selecting, by the one or more processing circuits, the routine from a plurality of routines capable of generating performance data sufficient to perform the evaluation.

In some embodiments, selecting the routine from the plurality of routines can include determining, by the one or more processing circuits, that the plurality of actions correlate to one or more aspects of the evaluation, and selecting, by the one or more processing circuits, the routine from the plurality of routines responsive to determination of the correlation between the plurality of actions and the one or more aspects.

At least one embodiment relates to one or more non-transitory storage media. The one or more non-transitory storage media can store instructions thereon. The instructions can, when executed by one or more processors, cause the one or more processors to perform operations that include receiving, via a user interface, a selection of a plurality of parameters associated with building equipment of a building. The plurality of parameters can correspond to one or more features of the building equipment. The operations can include identifying, based on the plurality of parameters, an evaluation to test a performance of the building equipment with respect to the one or more features. The operations can include determining, responsive to identification of the evaluation, a routine to perform the evaluation. The routine can include a plurality of actions that correspond to the evaluation. The operations can include retrieving, from a database, a plurality of control parameters configured to cause the building equipment to perform the plurality of actions. The operations can include transmitting, to the building equipment, control signals to cause the building equipment to execute the routine by adjusting values for the plurality of control parameters.

In some embodiments, a first control parameter of the plurality of control parameter includes a status parameter for the building equipment. A second control parameter of the plurality of control parameters includes a building parameter controllable by the building equipment.

In some embodiments, transmitting the control signals to execute the routine can include adjusting a building parameter from a first value to a second value to trigger a response from the building equipment, monitoring the response of the building equipment, and evaluating, based on the response of the building equipment, the performance of the building equipment with respect to the one or more features.

In some embodiments, the operations can include updating, responsive to completion of the evaluation, the user interface to include an indication of the performance of the building equipment. The indication of the performance of the building equipment can include a first string to indicate the evaluation that was performed, and a second string to explain the performance of the building equipment.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is drawing of a building equipped with a heating, ventilating, and air conditioning (HVAC) system, according to some embodiments.

FIG. 2 is a block diagram of a building management system (BMS) which can be used to monitor and control the building and HVAC system of FIG. 1, according to some embodiments.

FIG. 3 is a block diagram illustrating a system manager, zone coordinator, and zone controller of the BMS of FIG. 2 in greater detail, according to some embodiments.

FIG. 4 is a block diagram of a Building Automation System (BAS) which may be used to monitor and control building equipment in the building of FIG. 1, according to some embodiments.

FIG. 5 is a block diagram of a central plant which can be used to serve the energy loads of the building of FIG. 1, according to an exemplary embodiment.

FIG. 6 is a block diagram of an airside system which can be implemented in the building of FIG. 1, according to an exemplary embodiment.

FIG. 7 is a block diagram of a system for automated equipment testing and commissioning, according to some embodiments.

FIG. 8A is a flow diagram of a process for testing of building equipment, according to some embodiments.

FIG. 8B is a flow diagram of a process for testing of building equipment, according to some embodiments.

FIG. 9 is a user interface including selectable elements for building equipment, according to some embodiments.

FIG. 10 is a user interface including information associated with an evaluation, according to some embodiments.

FIG. 11 is a flow diagram for performing a test routine, according to some embodiments.

FIG. 12 is a flow diagram for performing a test routine, according to some embodiments.

FIG. 13 is a user interface including results of a test routine, according to some embodiments.

FIG. 14 is a flow diagram of a process for testing of building equipment, according to some embodiments.

### DETAILED DESCRIPTION

### Overview

Referring generally to the FIGURES, a building management system (BMS) with automatic equipment discovery and equipment model distribution is shown, according to some embodiments. A BMS is, in general, a system of devices configured to control, monitor, and manage equipment in or around a building or building area. A BMS can include a heating, ventilation, or air conditioning (HVAC) system, a security system, a lighting system, a fire alerting system, another system that is capable of managing building functions or devices, or any combination thereof. BMS devices may be installed in any environment (e.g., an indoor area or an outdoor area) and the environment may include any number of buildings, spaces, zones, rooms, or areas. A BMS may include VERASYS® building controllers or other devices sold by Johnson Controls, Inc., as well as building devices and components from other sources.

A Building Automation System (BAS) is, in general, a system of devices configured to control, monitor, and/or manage equipment in or around a building or building area. A BAS can include, for example, a HVAC system, a security system, a lighting system, a fire alerting system, any other system that is capable of managing building functions or devices, or any combination thereof.

In brief overview, the BMS described herein provides a system architecture that facilitates automatic equipment discovery and equipment model distribution. Equipment discovery can occur on multiple levels of the BMS across multiple different communications busses (e.g., a system bus, zone buses, a sensor/actuator bus, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, the BMS can begin interacting with the new device (e.g., sending control signals, using data from the device) without user interaction.

Some devices in the BMS present themselves to the network using equipment models. An equipment model defines equipment object attributes, view definitions, schedules, trends, and the associated BACnet value objects (e.g., analog value, binary value, multistate value, etc.) that are used for integration with other systems. Some devices in the BMS store their own equipment models. Other devices in the BMS have equipment models stored externally (e.g., within other devices). For example, a zone coordinator can store the equipment model for a bypass damper. In some embodiments, the zone coordinator automatically creates the equipment model for the bypass damper and/or other devices on the zone bus. Other zone coordinators can also create equipment models for devices connected to their zone busses. The equipment model for a device can be created automatically based on the types of data points exposed by the device on the zone bus, device type, and/or other device attributes.

BMSs and BASs may be controllable from a localized and/or an onsite premise. For example, a BMS may be controllable by an admin within a building. The admin may control the BMS using a computing device (e.g., a desktop computer, laptop, tablet, etc.). Controlling BMSs and/or BASs locally (e.g., within the building) may result in technicians and/or service providers being unable to evaluate and/or perform equipment test without first traveling to the building and then joining the network. The need for the technician to first travel to the building, prior to testing and/or evaluating equipment, may impact a duration of equipment startup time (e.g., how long a new piece of equipment is offline once installed and/or added to the BMS, etc.).

Some technical solutions described herein include a system architecture where a system and/or device may integrate with a building's BMS to perform and/or execute equipment evaluations without a user having to be on-premises (e.g., at the building) to integrate and/or activate the equipment. The remote integration (e.g., connecting the remote device to a BMS and/or a BAS of a building) of the remote device with various components of a building may result in quicker startup time and/or BMS integration time for equipment. For example, a technician may be able to evaluate that a new piece of building equipment is operating and/or performing within a predetermined threshold without having to be present within the building to test the new piece of equipment.

As recited herein “building equipment” can refer to and/or include individual devices or pieces of building equipment, sets of building equipment, systems including multiple devices of building equipment, or any combination thereof. In some embodiments, an evaluation may refer to and/or include at least one of a test or protocol to cause the piece of building equipment to perform a given action, a set of steps or actions to trigger action by a piece of building equipment, and/or a collection of control strategies or signals that cause equipment to perform a given task. In some embodiments, a performance may refer to and/or include at least one of an outcome or a result of a piece of equipment in performing an action or test, a list of actions performed by a piece of equipment, a quantitative result (e.g., pass, fail, etc.) of one or more actions taken by a piece of equipment, and/or an objective result of one or more actions.

### Building and HVAC System

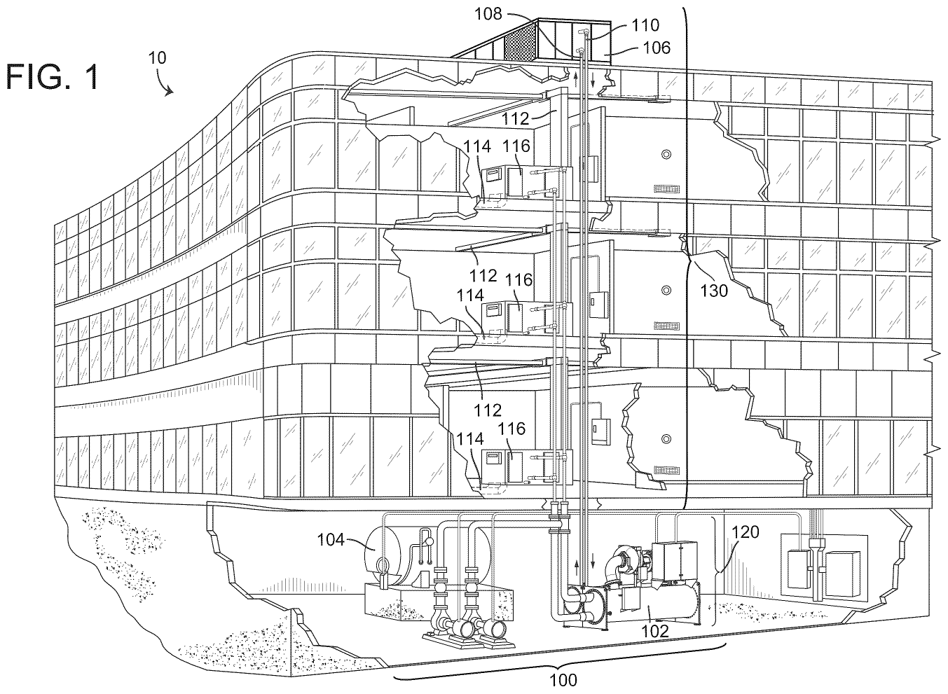

Referring now to FIG. 1, an exemplary building and HVAC system in which the systems and methods of the present invention can be implemented are shown, according to an exemplary embodiment. In FIG. 1, a perspective view of a building 10 is shown. Building 10 is served by a HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve setpoint conditions for the building zone.

### Building Management System

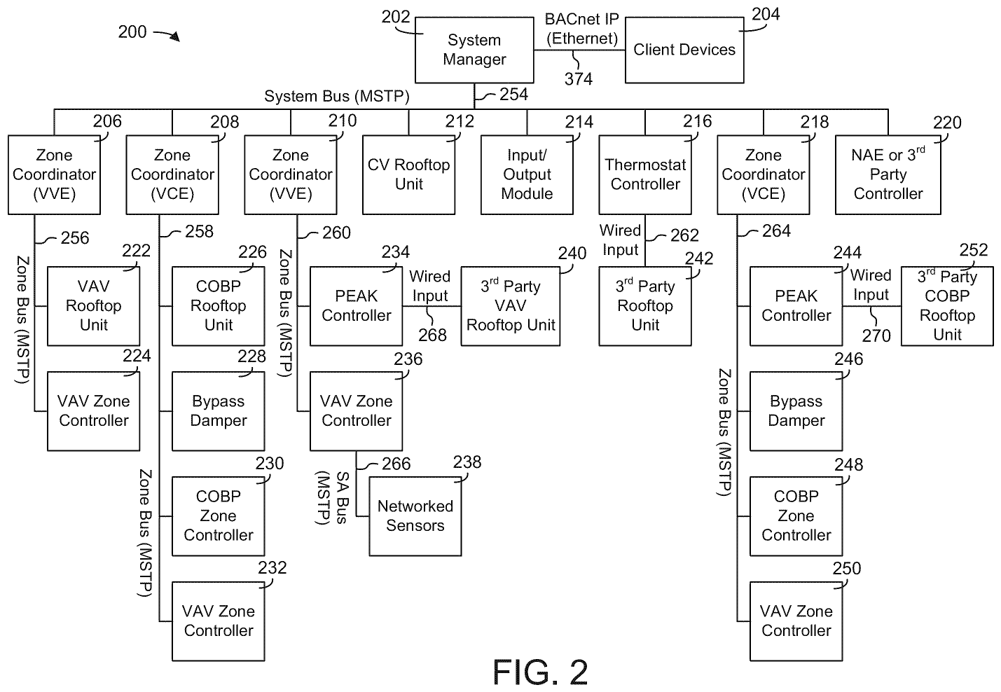

Referring now to FIG. 2, a block diagram of a building management system (BMS) 200 is shown, according to an exemplary embodiment. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof. BMS 200 can be used to monitor and control the devices of HVAC system 100 and/or airside system 130 (e.g., HVAC equipment) as well as other types of BMS devices (e.g., lighting equipment, security equipment, etc.).

In brief overview, BMS 200 provides a system architecture that facilitates automatic equipment discovery and equipment model distribution. Equipment discovery can occur on multiple levels of BMS 200 across multiple different communications busses (e.g., a system bus 254, zone buses 256-260 and 264, sensor/actuator bus 266, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 200 can begin interacting with the new device (e.g., sending control signals, using data from the device) without user interaction.

Some devices in BMS 200 present themselves to the network using equipment models. An equipment model defines equipment object attributes, view definitions, schedules, trends, and the associated BACnet value objects (e.g., analog value, binary value, multistate value, etc.) that are used for integration with other systems. An equipment model for a device can include a collection of point objects that provide information about the device (e.g., device name, network address, model number, device type, etc.) and store present values of variables or parameters used by the device. For example, the equipment model can include point objects (e.g., standard BACnet point objects) that store the values of input variables accepted by the device (e.g., setpoint, control parameters, etc.), output variables provided by the device (e.g., temperature measurement, feedback signal, etc.), configuration parameters used by the device (e.g., operating mode, actuator stroke length, damper position, tuning parameters, etc.). The point objects in the equipment model can be mapped to variables or parameters stored within the device to expose those variables or parameters to external systems or devices.

Some devices in BMS 200 store their own equipment models. Other devices in BMS 200 have equipment models stored externally (e.g., within other devices). For example, a zone coordinator 208 can store the equipment model for a bypass damper 228. In some embodiments, zone coordinator 208 automatically creates the equipment model for bypass damper 228 or other devices on zone bus 258. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 2, BMS 200 is shown to include a system manager 202; several zone coordinators 206, 208, 210 and 218; and several zone controllers 224, 230, 232, 236, 248, and 250. System manager 202 can communicate with client devices 204 (e.g., user devices, desktop computers, laptop computers, mobile devices, etc.) via a data communications link 374 (e.g., BACnet IP, Ethernet, wired or wireless communications, etc.). System manager 202 can provide a user interface to client devices 204 via data communications link 374. The user interface may allow users to monitor and/or control BMS 200 via client devices 204.

In some embodiments, system manager 202 is connected with zone coordinators 206-210 and 218 via a system bus 254. System bus 254 can include any of a variety of communications hardware (e.g., wire, optical fiber, terminals, etc.) configured to facilitate communications between system manager and other devices connected to system bus 254. Throughout this disclosure, the devices connected to system bus 254 are referred to as system bus devices. System manager 202 can be configured to communicate with zone coordinators 206-210 and 218 via system bus 254 using a master-slave token passing (MSTP) protocol or any other communications protocol. System bus 254 can also connect system manager 202 with other devices such as a constant volume (CV) rooftop unit (RTU) 212, an input/output module (IOM) 214, a thermostat controller 216 (e.g., a TEC2000 series thermostat controller), and a network automation engine (NAE) or third-party controller 220. RTU 212 can be configured to communicate directly with system manager 202 and can be connected directly to system bus 254. Other RTUs can communicate with system manager 202 via an intermediate device. For example, a wired input 262 can connect a third-party RTU 242 to thermostat controller 216, which connects to system bus 254.

System manager 202 can provide a user interface for any device containing an equipment model. Devices such as zone coordinators 206-210 and 218 and thermostat controller 216 can provide their equipment models to system manager 202 via system bus 254. In some embodiments, system manager 202 automatically creates equipment models for connected devices that do not contain an equipment model (e.g., IOM 214, third party controller 220, etc.). For example, system manager 202 can create an equipment model for any device that responds to a device tree request. The equipment models created by system manager 202 can be stored within system manager 202. System manager 202 can then provide a user interface for devices that do not contain their own equipment models using the equipment models created by system manager 202. In some embodiments, system manager 202 stores a view definition for each type of equipment connected via system bus 254 and uses the stored view definition to generate a user interface for the equipment.

Each zone coordinator 206-210 and 218 can be connected with one or more of zone controllers 224, 230-232, 236, and 248-250 via zone buses 256, 258, 260, and 264. Zone busses 256, 258, 260, and 264 can include any of a variety of communications hardware (e.g., wire, optical fiber, terminals, etc.) configured to facilitate communications between a zone coordinator and other devices connected to the corresponding zone bus. Throughout this disclosure, the devices connected to zone busses 256, 258, 260, and 264 are referred to as zone bus devices. Zone coordinators 206-210 and 218 can communicate with zone controllers 224, 230-232, 236, and 248-250 via zone busses 256-260 and 264 using a MSTP protocol or any other communications protocol. Zone busses 256-260 and 264 can also connect zone coordinators 206-210 and 218 with other types of devices such as variable air volume (VAV) RTUs 222 and 240, changeover bypass (COBP) RTUs 226 and 252, bypass dampers 228 and 246, and PEAK controllers 234 and 244.

Zone coordinators 206-210 and 218 can be configured to monitor and command various zoning systems. In some embodiments, each zone coordinator 206-210 and 218 monitors and commands a separate zoning system and is connected to the zoning system via a separate zone bus. For example, zone coordinator 206 can be connected to VAV RTU 222 and zone controller 224 via zone bus 256. Zone coordinator 208 can be connected to COBP RTU 226, bypass damper 228, COBP zone controller 230, and VAV zone controller 232 via zone bus 258. Zone coordinator 210 can be connected to PEAK controller 234 and VAV zone controller 236 via zone bus 260. Zone coordinator 218 can be connected to PEAK controller 244, bypass damper 246, COBP zone controller 248, and VAV zone controller 250 via zone bus 264.

A single model of zone coordinator 206-210 and 218 can be configured to handle multiple different types of zoning systems (e.g., a VAV zoning system, a COBP zoning system, etc.). Each zoning system can include a RTU, one or more zone controllers, and/or a bypass damper. For example, zone coordinators 206 and 210 are shown as Verasys VAV engines (VVEs) connected to VAV RTUs 222 and 240, respectively. Zone coordinator 206 is connected directly to VAV RTU 222 via zone bus 256, whereas zone coordinator 210 is connected to a third-party VAV RTU 240 via a wired input 268 provided to PEAK controller 234. Zone coordinators 208 and 218 are shown as Verasys COBP engines (VCEs) connected to COBP RTUs 226 and 252, respectively. Zone coordinator 208 is connected directly to COBP RTU 226 via zone bus 258, whereas zone coordinator 218 is connected to a third-party COBP RTU 252 via a wired input 270 provided to PEAK controller 244.

Zone controllers 224, 230-232, 236, and 248-250 can communicate with individual BMS devices (e.g., sensors, actuators, etc.) via sensor/actuator (SA) busses. For example, VAV zone controller 236 is shown connected to networked sensors 238 via SA bus 266. Networked sensors 238 can include, for example, temperature sensors, humidity sensors, pressure sensors, lighting sensors, security sensors, or any other type of device configured to measure and/or provide an input to zone controller 236. Zone controller 236 can communicate with networked sensors 238 using a MSTP protocol or any other communications protocol. Although only one SA bus 266 is shown in FIG. 2, it should be understood that each zone controller 224, 230-232, 236, and 248-250 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 224, 230-232, 236, and 248-250 can be configured to monitor and control a different building zone. Zone controllers 224, 230-232, 236, and 248-250 can use the inputs and outputs provided via their SA busses to monitor and control various building zones. For example, a zone controller 236 can use a temperature input received from networked sensors 238 via SA bus 266 (e.g., a measured temperature of a building zone) as feedback in a temperature control algorithm. Zone controllers 224, 230-232, 236, and 248-250 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

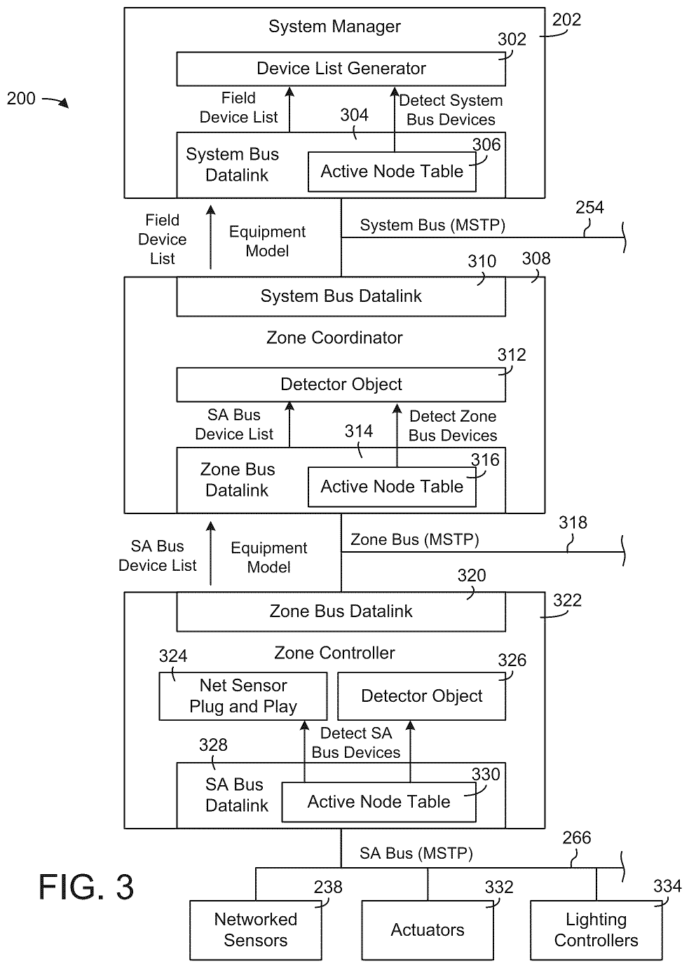

Referring now to FIG. 3, a block diagram illustrating a portion of BMS 200 in greater detail is shown, according to an exemplary embodiment. BMS 200 is shown to include system manager 202, a zone coordinator 308, and a zone controller 322. Zone coordinator 308 can be any of zone coordinators 206-210 or 218. Zone controller 322 can be any of zone controllers 224, 230, 232, 236, 248, or 250. Zone coordinator 308 can be connected with system manager via system bus 254. For example, system bus 254 is shown connecting a first system bus datalink 304 within system manager 202 with a second system bus datalink 310 within zone coordinator 308. Zone coordinator 308 can be connected with zone controller 322 via a zone bus 318. For example, zone bus 318 is shown connecting a first zone bus datalink 314 within zone coordinator 308 with a second zone bus datalink 320 within zone controller 322. Zone bus 318 can be any of zone busses 256-260 or 264. Zone controller 322 is connected with networked sensors 238 and actuators 332 via a SA bus 266.

BMS 200 can automatically discover new equipment connected to any of system bus 254, zone bus 318, and SA bus 266. Advantageously, the equipment discovery can occur automatically (e.g., without user action) without requiring the equipment to be placed in discovery mode and without sending a discovery command to the equipment. In some embodiments, the automatic equipment discovery is based on active node tables for system bus 254, zone bus 318, and SA bus 266. Each active node table can provide status information for the devices communicating on a particular bus. For example, the active node table 306 for system bus 254 can indicate which MSTP devices are participating in the token ring used to exchange information via system bus 254. Active node table 306 can identify the devices communicating on system bus 254 by MAC address or other device identifier. Devices that do not participate in the token ring (e.g., MSTP slave devices) can be automatically discovered using a net sensor plug and play (described in greater detail below).

The active node table for each communications bus can be stored within one or more devices connected to the bus. For example, active node table 306 can be stored within system manager 202. In some embodiments, active node table 306 is part of a system bus datalink 304 (e.g., a MSTP datalink) used by system manager 202 to communicate via system bus 254. System manager 202 can subscribe to changes in value of active node table 306 and can receive a notification (e.g., from system bus datalink 304) when a change in active node table 306. In response to a notification that a change in active node table 306 has occurred, system manager 202 can read active node table 306 to detect and identify the devices connected to system bus 254.

In some embodiments, a device list generator 302 within system manager 202 generates a list of the devices connected to system bus 254 (i.e., a device list) based on active node table 306 and stores the device list within system manager 202. The device list generated by system manager 202 can include information about each device connected to system bus 254 (e.g., device type, device model, device ID, MAC address, device attributes, etc.). When a new device is detected on system bus 254, system manager 202 can automatically retrieve the equipment model from the device if the device stores its own equipment model. If the device does not store its own equipment model, system manager 202 can retrieve a list of point values provided by the device. System manager 202 can then use the equipment model and/or list of point values to present information about the connected system bus devices to a user.

The active node tables for each zone bus can be stored within the zone coordinator connected to the zone bus. For example, the active node table 316 for zone bus 318 can be stored within zone coordinator 308. In some embodiments, active node table 316 is part of a zone bus datalink 314 (e.g., a MSTP datalink) used by the zone coordinator 308 to communicate via zone bus 318. Zone coordinator 308 can subscribe to changes in value of active node table 316 and can receive a notification (e.g., from zone bus datalink 314) when a change in active node table 316 occurs. In response to a notification that a change to active node table 316 has occurred, zone coordinator 308 can read active node table 316 to identify the devices connected to zone bus 318.

In some embodiments, a detector object 312 of zone coordinator 308 generates a list of the devices communicating on zone bus 318 (i.e., a device list) based on active node table 316 and stores the device list within zone coordinator 308. Each zone coordinator in BMS 200 can generate a list of devices on the connected zone bus. The device list generated by each zone coordinator 308 can include information about each device connected to zone bus 318 (e.g., device type, device model, device ID, MAC address, device attributes, etc.). When a new device is detected on zone bus 318, the connected zone coordinator 308 can automatically retrieve the equipment model from the device if the device stores its own equipment model. If the device does not store its own equipment model, the connected zone coordinator 308 can retrieve a list of point values provided by the device.

Zone coordinator 308 can incorporate the new zone bus device into the zoning logic and can inform system manager 202 that a new zone bus device has been added. For example, zone coordinator 308 is shown providing a field device list to system manager 202. The field device list can include a list of devices connected to zone bus 318 and/or SA bus 266. System manager 202 can use the field device list and the list of system bus devices to generate a device tree including all of the devices in BMS 200. In some embodiments, zone coordinator 308 provides an equipment model for a connected zone bus device to system manager 202. System manager 202 can then use the equipment model and/or list of point values for the new zone bus device to present information about the new zone bus device to a user.

In some embodiments, the device list generated by each zone coordinator 308 indicates whether system manager 202 should communicate directly with the listed zone bus device (e.g., VAV RTU 222, VAV zone controller 224, etc.) or whether system manager 202 should communicate with the intermediate zone coordinator 308 on behalf of the zone bus device. In some embodiments, system manager 202 communicates directly with zone bus devices that provide their own equipment models, but communicates with the intermediate zone coordinator 308 for zone bus devices that do not provide their own equipment model. As discussed above, the equipment models for zone bus devices that do not provide their own equipment model can be generated by the connected zone coordinator 308 and stored within the zone coordinator 308. Accordingly, system manager 202 may communicate directly with the device that stores the equipment model for a connected zone bus device (i.e., the zone bus device itself or the connected zone coordinator 308).

The active node table 330 for SA bus 266 can be stored within zone controller 322. In some embodiments, active node table 330 is part of the SA bus datalink 328 (e.g., a MSTP datalink) used by zone controller 322 to communicate via SA bus 266. Zone controller 322 can subscribe to changes in value of the active node table 330 and can receive a notification (e.g., from SA bus datalink 328) when a change in active node table 330 occurs. In response to a notification that a change to active node table 330 has occurred, zone controller 322 can read active node table 330 to identify some or all of the devices connected to SA bus 266. In some embodiments, active node table 330 identifies only the SA bus devices participating in the token passing ring via SA bus 266 (e.g., MSTP master devices). Zone controller 322 can include an additional net sensor plug and play (NsPnP) 324 configured to detect SA bus devices that do not participate in the token passing ring (e.g., MSTP slave devices).

In some embodiments, NsPnP 324 is configured to actively search for devices connected to SA bus 266 (e.g., networked sensors 238, actuators 332, lighting controllers 334, etc.). For example, NsPnP 324 can send a “ping” to a preconfigured list of MSTP slave MAC addresses. For each SA bus device that is discovered (i.e., responds to the ping), NsPnP 324 can dynamically bring it online. NsPnP 324 can bring a device online by creating and storing an instance of a SA bus device object representing the discovered SA bus device. NsPnP 324 can automatically populate the SA bus device object with all child point objects needed to collect and store point data (e.g., sensor data) from the newly discovered SA bus device. In some embodiments, NsPnP 324 automatically maps the child point objects of the SA bus device object to attributes of the equipment model for zone controller 322. Accordingly, the data points provided by the SA bus devices can be exposed to zone coordinator 308 and other devices in BMS 200 as attributes of the equipment model for zone controller 322.

In some embodiments, a detector object 326 of zone controller 322 generates a list of the devices connected to SA bus 266 (i.e., a device list) based on active node table 330 and stores the device list within zone controller 322. NsPnP 324 can update the device list to include any SA bus devices discovered by NsPnP 324. The device list generated by zone controller 322 can include information about each device connected to SA bus 266 (e.g., device type, device model, device ID, MAC address, device attributes, etc.). When a new device is detected on SA bus 266, zone controller 322 can automatically retrieve the equipment model from the device if the device stores its own equipment model. If the device does not store its own equipment model, zone controller 322 can retrieve a list of point values provided by the device.

Zone controller 322 can incorporate the new SA bus device into the zone control logic and can inform zone coordinator 308 that a new SA bus device has been added. Zone coordinator 308 can then inform system manager 202 that a new SA bus device has been added. For example, zone controller 322 is shown providing a SA device list to zone coordinator 308. The SA device list can include a list of devices connected to SA bus 266. Zone coordinator 308 can use the SA device list and the detected zone bus devices to generate the field device list provided to system manager 202. In some embodiments, zone controller 322 provides an equipment model for a connected SA bus device to zone coordinator 308, which can be forwarded to system manager 202. System manager 202 can then use the equipment model and/or list of point values for the new SA bus device to present information about the new SA bus device to a user. In some embodiments, data points provided by the SA bus device are shown as attributes of the zone controller 322 to which the SA bus device is connected.

Additional features and advantages of BMS 200, system manager 202, zone coordinator 308, and zone controller 322 are described in detail in U.S. patent application Ser. No. 15/179,894 filed Jun. 10, 2016, the entire disclosure of which is incorporated by reference herein.

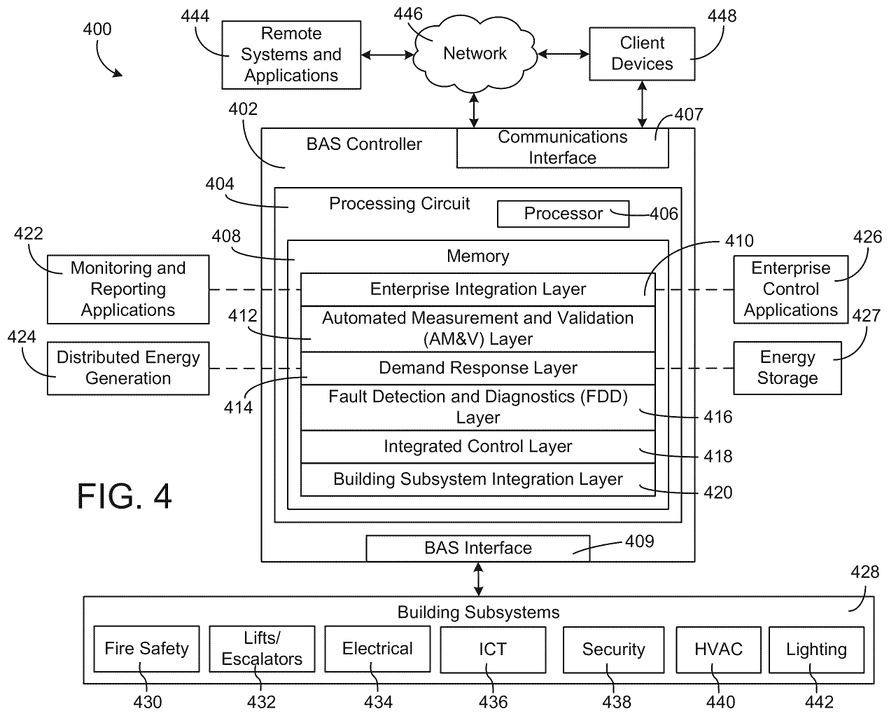

Referring now to FIG. 4, a block diagram of a building automation system (BAS) 400 is shown, according to an exemplary embodiment. BAS 400 may be implemented in building 10 to automatically monitor and control various building functions. BAS 400 is shown to include BAS controller 402 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 may include at least one of the various building systems and/or building subsystems described herein. For example, the building subsystems 428 may include airside system 130.

Each of building subsystems 428 may include any number of devices, controllers, and connections for completing its individual functions and control activities. HVAC subsystem 440 may include many of the same components as HVAC system 100. For example, HVAC subsystem 440 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BAS controller 402 is shown to include a communications interface 407 and a BAS interface 409. Interface 407 may facilitate communications between BAS controller 402 and external applications (e.g., monitoring and reporting applications 422, enterprise control applications 426, remote systems and applications 444, applications residing on client devices 448, etc.) for allowing user control, monitoring, and adjustment to BAS controller 402 and/or subsystems 428. Interface 407 may also facilitate communications between BAS controller 402 and client devices 448. BAS interface 409 may facilitate communications between BAS controller 402 and building subsystems 428 (e.g., HVAC, lighting security, lifts, power distribution, business, etc.).

Interfaces 407, 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407, 409 may be direct (e.g., local wired or wireless communications) or via a communications network 446 (e.g., a WAN, the Internet, a cellular network, etc.). For example, interfaces 407, 409 can include an Ethernet card and port for sending and receiving data via an Ethernet-based communications link or network. In another example, interfaces 407, 409 can include a Wi-Fi transceiver for communicating via a wireless communications network. In another example, one or both of interfaces 407, 409 may include cellular or mobile phone communications transceivers. In one embodiment, communications interface 407 is a power line communications interface and BAS interface 409 is an Ethernet interface. In other embodiments, both communications interface 407 and BAS interface 409 are Ethernet interfaces or are the same Ethernet interface.

Still referring to FIG. 4, BAS controller 402 is shown to include a processing circuit 404 including a processor 406 and memory 408. Processing circuit 404 may be communicably connected to BAS interface 409 and/or communications interface 407 such that processing circuit 404 and the various components thereof can send and receive data via interfaces 407, 409. Processor 406 can be implemented as a general-purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BAS controller 402 is implemented within a single computer (e.g., one server, one housing, etc.). In various other embodiments, BAS controller 402 may be distributed across multiple servers or computers (e.g., that can exist in distributed locations). Further, while FIG. 4 shows applications 422 and 426 as existing outside of BAS controller 402, in some embodiments, applications 422 and 426 may be hosted within BAS controller 402 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BAS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BAS controller 402. In yet other embodiments, enterprise control applications 426 can work with layers 410-420 to optimize building performance (e.g., efficiency, energy use, comfort, or safety) based on inputs received at interface 407 and/or BAS interface 409.

Building subsystem integration layer 420 may be configured to manage communications between BAS controller 402 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427, or from other sources. Demand response layer 414 may receive inputs from other layers of BAS controller 402 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions can specify which equipment may be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 may be configured to provide calculated inputs (e.g., aggregations) to these higher levels based on outputs from more than one building subsystem.

Automated measurement and validation (AM&V) layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BAS devices or subsystems. For example, AM&V layer 412 may compare a model-predicted output with an actual output from building subsystems 428 to determine an accuracy of the model.

Fault detection and diagnostics (FDD) layer 416 may be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BAS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

### Central Plant

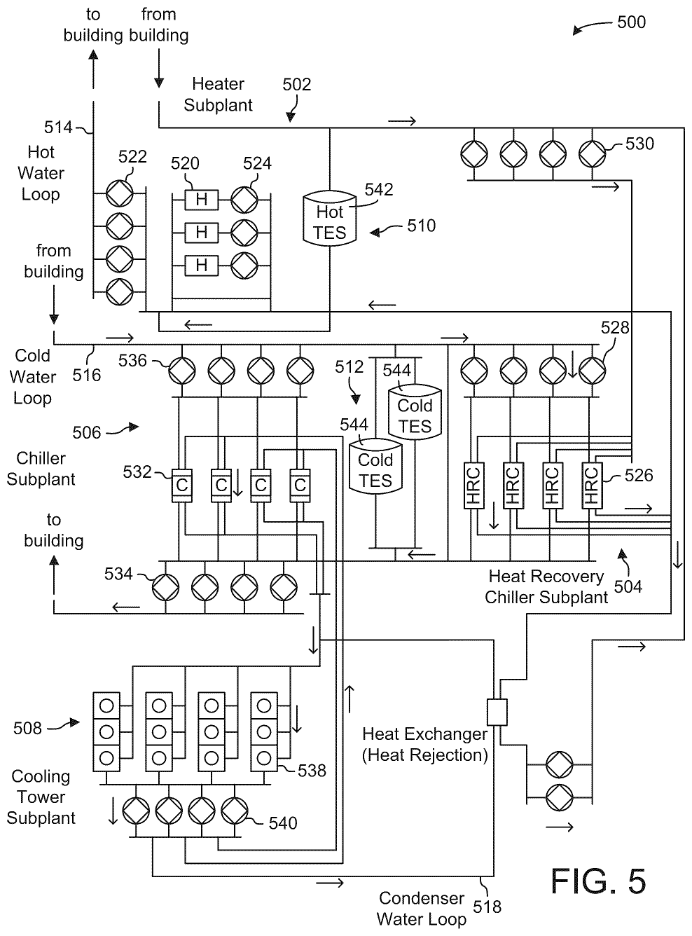

Referring now to FIG. 5, a block diagram of a central plant 500 is shown, according to some embodiments. In various embodiments, central plant 500 can supplement or replace waterside system 120 in HVAC system 100 or can be implemented separate from HVAC system 100. When implemented in HVAC system 100, central plant 500 can include a subset of the HVAC devices in HVAC system 100 (e.g., boiler 104, chiller 102, pumps, valves, etc.) and may operate to supply a heated or chilled fluid to AHU 106. The HVAC devices of central plant 500 can be located within building 10 (e.g., as components of waterside system 120) or at an offsite location such as a central energy facility that serves multiple buildings.

Central plant 500 is shown to include a plurality of subplants 502-508. Subplants 502-508 can be configured to convert energy or resource types (e.g., water, natural gas, electricity, etc.). For example, subplants 502-508 are shown to include a heater subplant 502, a heat recovery chiller subplant 504, a chiller subplant 506, and a cooling tower subplant 508. In some embodiments, subplants 502-508 consume resources purchased from utilities to serve the energy loads (e.g., hot water, cold water, electricity, etc.) of a building or campus. For example, heater subplant 502 can be configured to heat water in a hot water loop 514 that circulates the hot water between heater subplant 502 and building 10. Similarly, chiller subplant 506 can be configured to chill water in a cold water loop 516 that circulates the cold water between chiller subplant 506 building 10.

Heat recovery chiller subplant 504 can be configured to transfer heat from cold water loop 516 to hot water loop 514 to provide additional heating for the hot water and additional cooling for the cold water. Condenser water loop 518 may absorb heat from the cold water in chiller subplant 506 and reject the absorbed heat in cooling tower subplant 508 or transfer the absorbed heat to hot water loop 514. In various embodiments, central plant 500 can include an electricity subplant (e.g., one or more electric generators) configured to generate electricity or any other type of subplant configured to convert energy or resource types.

Hot water loop 514 and cold water loop 516 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 502-508 to receive further heating or cooling.

Although subplants 502-508 are shown and described as heating and cooling water for circulation to a building, it is understood that any other type of working fluid (e.g., glycol, CO₂, etc.) can be used in place of or in addition to water to serve thermal energy loads. In other embodiments, subplants 502-508 may provide heating and/or cooling directly to the building or campus without requiring an intermediate heat transfer fluid. These and other variations to central plant 500 are within the teachings of the present disclosure.

Each of subplants 502-508 can include a variety of equipment configured to facilitate the functions of the subplant. For example, heater subplant 502 is shown to include a plurality of heating elements 520 (e.g., boilers, electric heaters, etc.) configured to add heat to the hot water in hot water loop 514. Heater subplant 502 is also shown to include several pumps 522 and 524 configured to circulate the hot water in hot water loop 514 and to control the flow rate of the hot water through individual heating elements 520. Chiller subplant 506 is shown to include a plurality of chillers 532 configured to remove heat from the cold water in cold water loop 516. Chiller subplant 506 is also shown to include several pumps 534 and 536 configured to circulate the cold water in cold water loop 516 and to control the flow rate of the cold water through individual chillers 532.

Heat recovery chiller subplant 504 is shown to include a plurality of heat recovery heat exchangers 526 (e.g., refrigeration circuits) configured to transfer heat from cold water loop 516 to hot water loop 514. Heat recovery chiller subplant 504 is also shown to include several pumps 528 and 530 configured to circulate the hot water and/or cold water through heat recovery heat exchangers 526 and to control the flow rate of the water through individual heat recovery heat exchangers 526. Cooling tower subplant 508 is shown to include a plurality of cooling towers 538 configured to remove heat from the condenser water in condenser water loop 518. Cooling tower subplant 508 is also shown to include several pumps 540 configured to circulate the condenser water in condenser water loop 518 and to control the flow rate of the condenser water through individual cooling towers 538.

In some embodiments, one or more of the pumps in central plant 500 (e.g., pumps 522, 524, 528, 530, 534, 536, and/or 540) or pipelines in central plant 500 include an isolation valve associated therewith. Isolation valves can be integrated with the pumps or positioned upstream or downstream of the pumps to control the fluid flows in central plant 500. In various embodiments, central plant 500 can include more, fewer, or different types of devices and/or subplants based on the particular configuration of central plant 500 and the types of loads served by central plant 500.

Still referring to FIG. 5, central plant 500 is shown to include hot thermal energy storage (TES) 510 and cold thermal energy storage (TES) 512. Hot TES 510 and cold TES 512 can be configured to store hot and cold thermal energy for subsequent use. For example, hot TES 510 can include one or more hot water storage tanks 542 configured to store the hot water generated by heater subplant 502 or heat recovery chiller subplant 504. Hot TES 510 may also include one or more pumps or valves configured to control the flow rate of the hot water into or out of hot TES tank 542.

Similarly, cold TES 512 can include one or more cold water storage tanks 544 configured to store the cold water generated by chiller subplant 506 or heat recovery chiller subplant 504. Cold TES 512 may also include one or more pumps or valves configured to control the flow rate of the cold water into or out of cold TES tanks 544. In some embodiments, central plant 500 includes electrical energy storage (e.g., one or more batteries) or any other type of device configured to store resources. The stored resources can be purchased from utilities, generated by central plant 500, or otherwise obtained from any source.

### Airside System

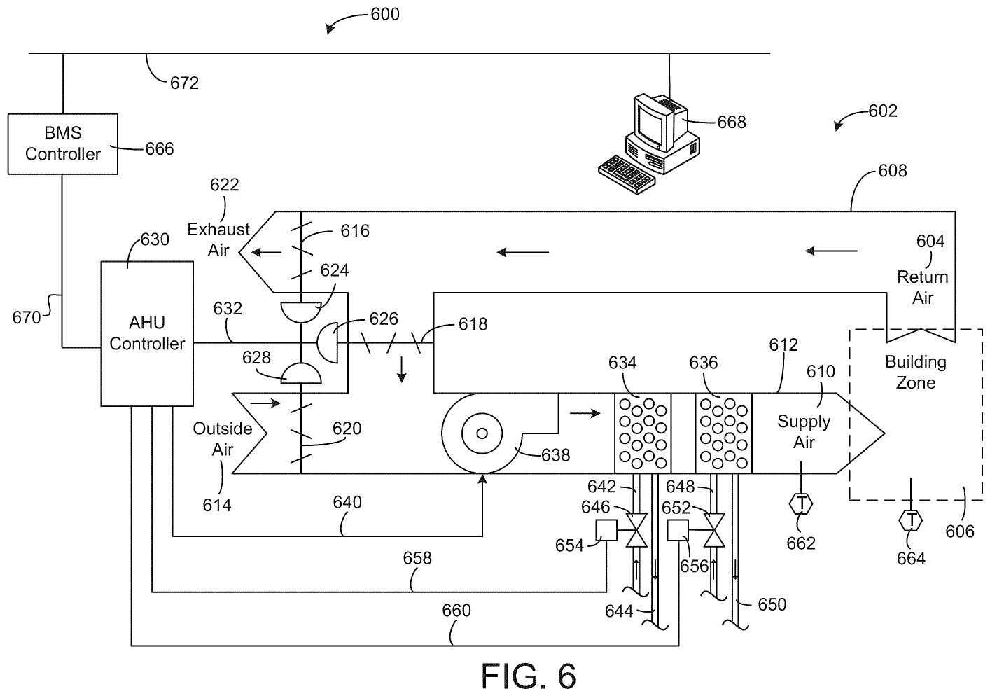

Referring now to FIG. 6, a block diagram of an airside system 600 is shown, according to some embodiments. In various embodiments, airside system 600 may supplement or replace airside system 130 in HVAC system 100 or can be implemented separate from HVAC system 100. When implemented in HVAC system 100, airside system 600 can include a subset of the HVAC devices in HVAC system 100 (e.g., AHU 106, VAV units 116, ducts 112-114, fans, dampers, etc.) and can be located in or around building 10. Airside system 600 may operate to heat or cool an airflow provided to building 10 using a heated or chilled fluid provided by central plant 500.

Airside system 600 is shown to include an economizer-type air handling unit (AHU) 602. Economizer-type AHUs vary the amount of outside air and return air used by the air handling unit for heating or cooling. For example, AHU 602 may receive return air 604 from building zone 606 via return air duct 608 and may deliver supply air 610 to building zone 606 via supply air duct 612. In some embodiments, AHU 602 is a rooftop unit located on the roof of building 10 (e.g., AHU 106 as shown in FIG. 1) or otherwise positioned to receive both return air 604 and outside air 614. AHU 602 can be configured to operate exhaust air damper 616, mixing damper 618, and outside air damper 620 to control an amount of outside air 614 and return air 604 that combine to form supply air 610. Any return air 604 that does not pass through mixing damper 618 can be exhausted from AHU 602 through exhaust damper 616 as exhaust air 622.

Each of dampers 616-620 can be operated by an actuator. For example, exhaust air damper 616 can be operated by actuator 624, mixing damper 618 can be operated by actuator 626, and outside air damper 620 can be operated by actuator 628. Actuators 624-628 may communicate with an AHU controller 630 via a communications link 632. Actuators 624-628 may receive control signals from AHU controller 630 and may provide feedback signals to AHU controller 630. Feedback signals can include, for example, an indication of a current actuator or damper position, an amount of torque or force exerted by the actuator, diagnostic information (e.g., results of diagnostic tests performed by actuators 624-628), status information, commissioning information, configuration settings, calibration data, and/or other types of information or data that can be collected, stored, or used by actuators 624-628. AHU controller 630 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 624-628.

Still referring to FIG. 6, AHU 602 is shown to include a cooling coil 634, a heating coil 636, and a fan 638 positioned within supply air duct 612. Fan 638 can be configured to force supply air 610 through cooling coil 634 and/or heating coil 636 and provide supply air 610 to building zone 606. AHU controller 630 may communicate with fan 638 via communications link 640 to control a flow rate of supply air 610. In some embodiments, AHU controller 630 controls an amount of heating or cooling applied to supply air 610 by modulating a speed of fan 638.

Cooling coil 634 may receive a chilled fluid from central plant 500 (e.g., from cold water loop 516) via piping 642 and may return the chilled fluid to central plant 500 via piping 644. Valve 646 can be positioned along piping 642 or piping 644 to control a flow rate of the chilled fluid through cooling coil 634. In some embodiments, cooling coil 634 includes multiple stages of cooling coils that can be independently activated and deactivated (e.g., by AHU controller 630, by BMS controller 666, etc.) to modulate an amount of cooling applied to supply air 610.

Heating coil 636 may receive a heated fluid from central plant 500 (e.g., from hot water loop 514) via piping 648 and may return the heated fluid to central plant 500 via piping 650. Valve 652 can be positioned along piping 648 or piping 650 to control a flow rate of the heated fluid through heating coil 636. In some embodiments, heating coil 636 includes multiple stages of heating coils that can be independently activated and deactivated (e.g., by AHU controller 630, by BMS controller 666, etc.) to modulate an amount of heating applied to supply air 610.

Each of valves 646 and 652 can be controlled by an actuator. For example, valve 646 can be controlled by actuator 654 and valve 652 can be controlled by actuator 656. Actuators 654-656 may communicate with AHU controller 630 via communications links 658-660. Actuators 654-656 may receive control signals from AHU controller 630 and may provide feedback signals to AHU controller 630. In some embodiments, AHU controller 630 receives a measurement of the supply air temperature from a temperature sensor 662 positioned in supply air duct 612 (e.g., downstream of cooling coil 634 and/or heating coil 636). AHU controller 630 may also receive a measurement of the temperature of building zone 606 from a temperature sensor 664 located in building zone 606.

In some embodiments, AHU controller 630 operates valves 646 and 652 via actuators 654-656 to modulate an amount of heating or cooling provided to supply air 610 (e.g., to achieve a setpoint temperature for supply air 610 or to maintain the temperature of supply air 610 within a setpoint temperature range). The positions of valves 646 and 652 affect the amount of heating or cooling provided to supply air 610 by cooling coil 634 or heating coil 636 and may correlate with the amount of energy consumed to achieve a desired supply air temperature. AHU controller 630 may control the temperature of supply air 610 and/or building zone 606 by activating or deactivating coils 634-636, adjusting a speed of fan 638, or a combination of both.

Still referring to FIG. 6, airside system 600 is shown to include a building management system (BMS) controller 666 and a client device 668. BMS controller 666 can include one or more computer systems (e.g., servers, supervisory controllers, subsystem controllers, etc.) that serve as system level controllers, application or data servers, head nodes, or master controllers for airside system 600, central plant 500, HVAC system 100, and/or other controllable systems that serve building 10. BMS controller 666 may communicate with multiple downstream building systems or subsystems (e.g., HVAC system 100, a security system, a lighting system, central plant 500, etc.) via a communications link 670 according to like or disparate protocols (e.g., LON, BACnet, etc.). In various embodiments, AHU controller 630 and BMS controller 666 can be separate (as shown in FIG. 6) or integrated. In an integrated implementation, AHU controller 630 can be a software module configured for execution by a processor of BMS controller 666.

In some embodiments, AHU controller 630 receives information from BMS controller 666 (e.g., commands, setpoints, operating boundaries, etc.) and provides information to BMS controller 666 (e.g., temperature measurements, valve or actuator positions, operating statuses, diagnostics, etc.). For example, AHU controller 630 may provide BMS controller 666 with temperature measurements from temperature sensors 662-664, equipment on/off states, equipment operating capacities, and/or any other information that can be used by BMS controller 666 to monitor or control a variable state or condition within building zone 606.

Client device 668 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 668 can be a computer workstation, a client terminal, a remote or local interface, or any other type of user interface device. Client device 668 can be a stationary terminal or a mobile device. For example, client device 668 can be a desktop computer, a computer server with a user interface, a laptop computer, a tablet, a smartphone, a PDA, or any other type of mobile or non-mobile device. Client device 668 may communicate with BMS controller 666 and/or AHU controller 630 via communications link 672.

### Automated Equipment Testing And Commissioning

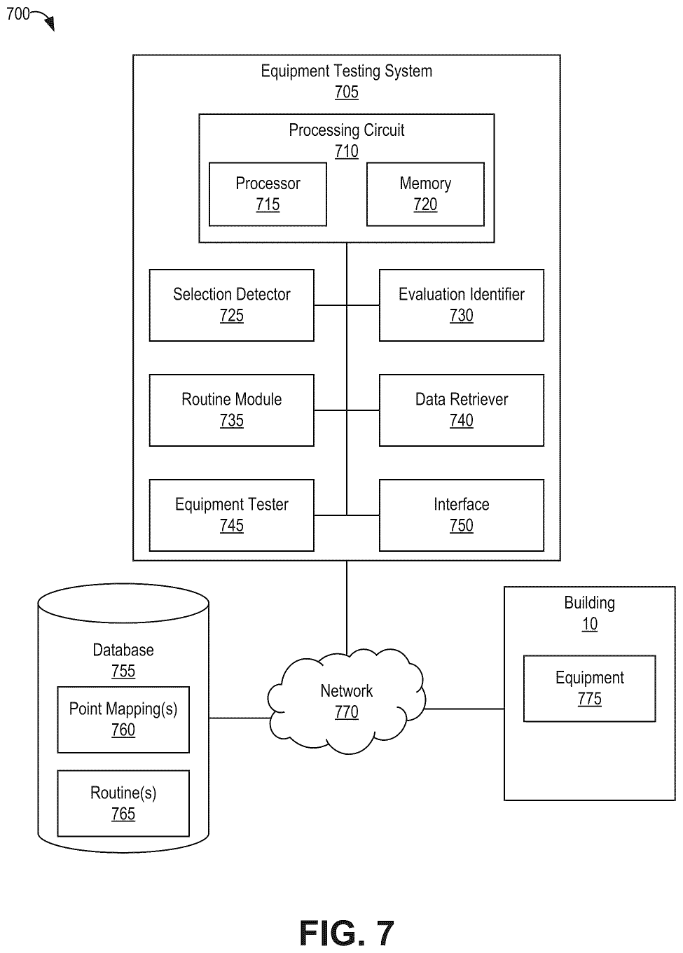

FIG. 7 is a block diagram of a system 700, according to some embodiments. The system 700 may include and/or be implemented as at least one of the various systems described herein. For example, the system 700 may be implemented as the BAS 400. In some embodiments, the system 700 may include at least one of the devices and/or components described herein. For example, the system 700 may include the network 446. In some embodiments, systems, components, and/or devices of the system 700 may be added, removed, integrated, combined, separated, rearranged, relocated, and/or replaced. For example, a device of the system 700 that may be shown to include two components may be modified such that the two components are combined into a single component. As another example, a component that is shown to be included in a first device may also be added to a second device. Each system or device in the system 700 may include one or more processors, memories, network interfaces, and user interfaces. The memories may store programming logic that, when executed by the processors, controls the operation of a corresponding computing system or device. The memories may also store data in databases.

In some embodiments, the system 700 may include at least one equipment testing system 705, at least one database 755, at least one network 770, and the building 10. In some embodiments, systems, devices, and/or components of the system 700 may be in communication with one another. For example, a first device may transmit signals to a second device. In some embodiments, the communication may include wireless communication. For example, the communication may include communication via a Wireless Local Area network (WLAN). In some embodiments, the communication may include wired communication. For example, the communication may include communication via wires and/or cables.

In some embodiments, the database 755 may include at least one of servers, remote computing systems, a cloud-based system, remote databases, and/or other possible cloud computing systems. In some embodiments, the database 755 may include similar components to at least one of the various systems and/or devices described herein. For example, the database 755 may include the BAS controller 402. In some embodiments, the database 755 may perform operations similar to that of at least one component and/or device described herein. For example, the database 755 may perform operations similar to that of monitoring and reporting applications 422. While FIG. 7 depicts the database 755 as being separate from the equipment testing system 705, the database 755 may be integrated in and/or included in the equipment testing system 705. In some embodiments, the database 755 may house and/or implement the equipment testing system 705. For example, the equipment testing system 705 may be distributed across one or more remote databases (e.g., the database 755).

In some embodiments, the database 755 may include at least one of the various types of memory and/or memory devices described herein. For example, the database 755 may include memory 408. In some embodiments, the database 755 may store and/or include one or more point mappings 760 and one or more routines 765. In some embodiments, the point mappings 760 may include at least one of the various mappings described herein. For example, the point mappings 760 may include mappings between point objects and one or more variables. As another example, the point mappings may map pieces of equipment and/or equipment types to one or more parameters. In some embodiments, the point mappings 760 may include relationships between one or more aspects of the building 10. For example, the point mappings may indicate that a given AHU (e.g., a piece of equipment) has given setpoints (e.g., one or more parameters). As another example, the points mappings may indicate that a given controller is communicably coupled with a given VAV and that the given controller is able to control the given VAV.

In some embodiments, the routines 765 may include at least one of testing criteria, testing metrics, testing parameters, and/or testing elements. For example, the routines 765 may include actions to adjust equipment parameters. As another example, the routines 765 may include equipment performance metrics. Ins some embodiments, the routines 765 may include setpoint relationships. For example, the routines 765 may include a relationship between zone temperature and a heating setpoint.

In some embodiments, the building 10 may include equipment 775 and/or pieces of equipment 775. In some embodiments, the equipment 775 may include at least one of the various pieces of equipment and/or equipment systems described herein. For example, the equipment 775 may include AHU 106. In some embodiments, the equipment 775 may be controllable by a controller. For example, the equipment 775 may be controllable by the BAS controller 402. In some embodiments, the building 10 may include at least one of gateways, switches, routers, network devices, hubs, bridges, and/or other possible devices that may connect one or more devices to one another. For example, the building 10 may include a gateway and the gateway may connect, over a network, a first device with a second device. In some embodiments, the gateway may connect the equipment testing system 705 with at least one component and/or device of the building 10. For example, the gateway may connect the equipment testing system 705 with the equipment 775.

In some embodiments, the equipment testing system 705 may be housed and/or located within the building 10 and the equipment testing system 705 may be communicably coupled with the equipment 775. In some embodiments, the equipment testing system 705 may be integrated and/or in communication with a mobile device. For example, the equipment testing system 705 may be in communication with the client devices 668. In some embodiments, a user and/or an operator of the client device 668 may integrate, via the client device 668, with the equipment testing system 705 and the client device 668 may perform at least one of the various operations described herein. In some embodiments, the equipment testing system 705 may be in communication with at least one of a smartphone, a tablet, a smart watch, a computer, a laptop, a desktop computer, and/or a device that may facilitate receiving and/or transmitting of information.

In some embodiments, the equipment testing system 705 may include at least one processing circuit 710, at least one selection detector 725, at least one evaluation identifier 730, at least one routine module 735, at least one data retriever 740, at least one equipment tester 745, and at least one interface 750. In some embodiments, the interface 750 may include at least one of a Human-Machine Interface (HMI), a communication interface, a network interface, a transmitter, an antenna, a receiver, and/or a transceiver. In some embodiments, the interface 750 may include at least one display device (e.g., a screen, a monitor, a Liquid Crystal Display (LCD) screen, a touch screen, an Input/Output (I/O) device, and/or other possible devices). In some embodiments, the interface 750 may communicate with at least one of the devices and/or components of the system 700. For example, the interface 750 may communicate with the equipment 775. In some embodiments, the processing circuit 710 may perform operations similar to that of the interface 750.

In some embodiments, the processing circuit 710 may include at least one processor 715 and at least one memory 720. In some embodiments, the processors 715 may include at least one of the various processors, hardware, and/or circuitry described herein. In some embodiments, memory 720 may include at least one of the various types of memory described herein. In some embodiments, memory 720 may store instructions (e.g., computer code, software, and/or firmware. In some embodiments, the processors 715 may perform at least one of the various operations described herein responsive to the processors 715 executing instructions stored in memory 720. In some embodiments, memory 720 may store and/or include the database 755.

In some embodiments, one or more operations that have been described as being performed by a first system, a first device, and/or a first component may also be performed by a second system, a second device, and/or a second component. For example, operations that have been described as being performed by the equipment testing system 705 may also be performed by the database 755. In some embodiments, at least one of the various systems, devices, and/or components described herein may perform at least one of the various operations and/or processes described as being performed by the equipment testing system 705.

In some embodiments, the equipment testing system 705 may generate, provide, produce, and/or display at least one user interface. For example, the equipment testing system 705 may display at least one Graphical User Interface (GUI). In some embodiments, the user interfaces may be displayed via the interface 750. In some embodiments, the interface 750 may transmit signals to one or more devices and the one or more devices may display, responsive to receipt of the signals, one or more user interfaces. For example, the interface 750 may transmit signals to the client devices 668 and the signals may cause the client devices 668 to display one or more user interfaces.

In some embodiments, the user interfaces may include, indicate, and/or list one or more pieces of equipment. For example, the user interface may include pieces of equipment (e.g., equipment 775) that are located and/or that service a given room, zone, floor, and/or portion of the building 10. In some embodiments, the user interfaces may include one or more parameters associated with the pieces of building equipment. For example, the user interface may include an indication of a VAV, and the user interface may also include temperature setpoint information (e.g., one or more parameters). In some embodiments, the parameters may correspond to one or more features of the pieces of building equipment. For example, the VAV may provide zone control (e.g., temperature control, humidity control, etc.) and the user interface may indicate given components (e.g., features) of the VAV that may perform various parts of the zone control. To continue this example, the VAV may include dampers and actuators, and the user interface may indicate one or more types of dampers and/or actuators.

In some embodiments, the one or more features of the building equipment may include building components (e.g., dampers, actuators, valves, pumps, etc.), actions of the building components (e.g., damper opens, valve closes, actuator extends, etc.), and results associated with the actions. For example, when a heating valve, that provides heated air to a duct, moves from a closed position to an open position a temperature within the duct may increase (e.g., heated air is provided to the duct). To continue this example, the performance of the building equipment with respect to the one or more features may include determining that the building equipment is operating responsive to detecting that the valve moved to the open position and responsive to detecting an increase in the temperature within the duct.

In some embodiments, the selection detector 725 may receive a selection of one or more parameters. For example, the selection detector 725 may receive a selection of parameters displayed in a user interface. In some embodiments, the selection detector 725 may receive the selection via a GUI. In some embodiments, the selection detector 725 may receive a selection of parameters associated with one or more pieces of building equipment. For example, the selection detector 725 may receive a selection of a zone control for a box reheat coil control. In some embodiments, the selection detector 725 may communicate with at least one component of the equipment testing system 705. For example, the selection detector 725 may communicate with the evaluation identifier 730. In some embodiments, the selection detector 725 may communicate with the evaluation identifier 730 responsive to the selection detector 725 receiving a selection.

In some embodiments, the evaluation identifier 730 may receive, from the selection detector 725, information pertaining to the selection. For example, the evaluation identifier 730 may receive the parameters associated with the pieces of building equipment. In some embodiments, the parameters may include at least one of the various aspects and/or characteristics of the various pieces of building equipment and/or equipment types described herein.

In some embodiments, the evaluation identifier 730 may identify one or more evaluations. For example, the evaluation identifier 730 may identify evaluations for a given piece of building equipment. In some embodiments, the evaluation identifier 730 may identify an evaluation to test a performance of a piece of building equipment. For example, the evaluation identifier 730 may identify an evaluation to test the equipment 775. In some embodiments, the evaluation identifier 730 may identify the evaluation based on the plurality of parameters. For example, the plurality of parameters may be associated with and/or linked to one or more evaluations. Stated otherwise, parameters for a given piece of equipment may be linked to various evaluations.

In some embodiments, the parameters associated with the piece of equipment may pertain to one or more actions taken and/or performed by the piece of equipment. For example, the parameters may pertain to a heating cycle that is performed by a VAV. To continue this example, the evaluation to test the performance of the VAV may include actions that VAV takes and/or performs to complete and/or execute the heating cycle.

As a non-limiting example, the evaluation to test a performance of a piece of building equipment may include Safety Interlock Precheck Tests, Startup Sequence Tests, Individual Control Loop Tests, Shutdown Sequence Tests, and/or Alarms Tests. To continue this non-limiting example, the Safety Interlock Precheck Tests may include safety interlocks (e.g., Low Temp Alarm, High Static Shutdown, Isolation Damper/Valve failure, etc.). To continue this non-limiting example, the Startup Sequence Tests may include evaluations which are to be carried out when a unit is enabled (e.g., check if a damper is opening before a fan is turned on). To continue this non-limiting example, the Individual Control Loop Tests may include evaluations that are associated with control loops (e.g., cooling valve control, heating valve control, fan speed modulation control, etc.). To continue this non-limiting example, the Shutdown Sequence Tests may include evaluations that may be carried out at the end when a unit is commanded to shutdown (e.g., check if a fan is shutting down before a damper is closed). To continue this non-limiting example, Alarms Tests may include evaluations that are associated with alarms (e.g., Fan Mismatch Alarm, Fan in Hand Alarm, etc.).

In some embodiments, the evaluation identifier 730 may communicate with the routine module 735. For example, the evaluation identifier 730 may provide the evaluations to the routine module 735. In some embodiments, routine module 735 may determine one or more routines. For example, the routine module 735 may determine routines to perform the evaluations. Stated otherwise, the evaluation may include a startup sequence for a given piece of building equipment and the routine may include one or more steps and/or actions to perform the startup sequence.

In some embodiments, the routine module 735 may retrieve, from the database 755, the routines 765. For example, the routine module 735 may identify and/or select the routines 765 based on the evaluation and/or the selected parameters. As another example, a given evaluation may include one or more routines (e.g., routines 765) and the routine module 735 may determine the routines based on the corresponding evaluation.

In some embodiments, the routine module 735 may provide the routines 765 to the data retriever 740. For example, the routine module 735 may provide an indication of the determined routines to the data retriever 740. In some embodiments, the data retriever 740 may retrieve one or more parameters. For example, the data retriever 740 may retrieve setpoints, values, parameters, and/or measurements. In some embodiments, the parameters may include equipment status (e.g., damper open, damper closed, fan on, fan off, lights on, lights off, etc.). In some embodiments, the parameters may include building metrics and/or building information. For example, the parameters may include zone temperature readings, occupancy of the building, and/or various other information.

In some embodiments, the equipment tester 745 may control one or more pieces of building equipment. For example, the equipment tester 745 may generate equipment setpoints, equipment states changes, equipment actions, and/or equipment responses. In some embodiments, the equipment tester 745 may use control parameters to control the equipment. For example, the evaluation may include testing an VAV's performance during a heating cycle. To continue this example, the equipment tester 745 may use a heating setpoint (e.g., a control parameter) for the VAV and a zone temperature (e.g., a control parameter) for a zone that is serviced by the VAV to control the equipment.

In some embodiments, the interface 750 may transmit one or more signals to the equipment 775. For example, the interface 750 may transmit signals that include equipment setpoints generated by the equipment tester 745. In some embodiments, the signals may include control signals. For example, the interface 750 may transmit control signals that cause the equipment to execute the routine.

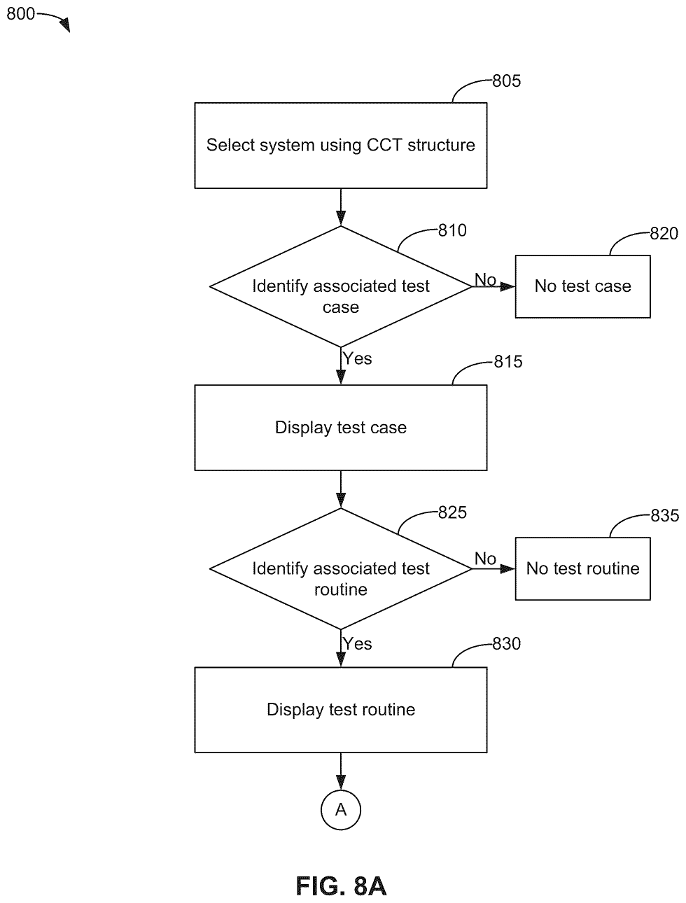

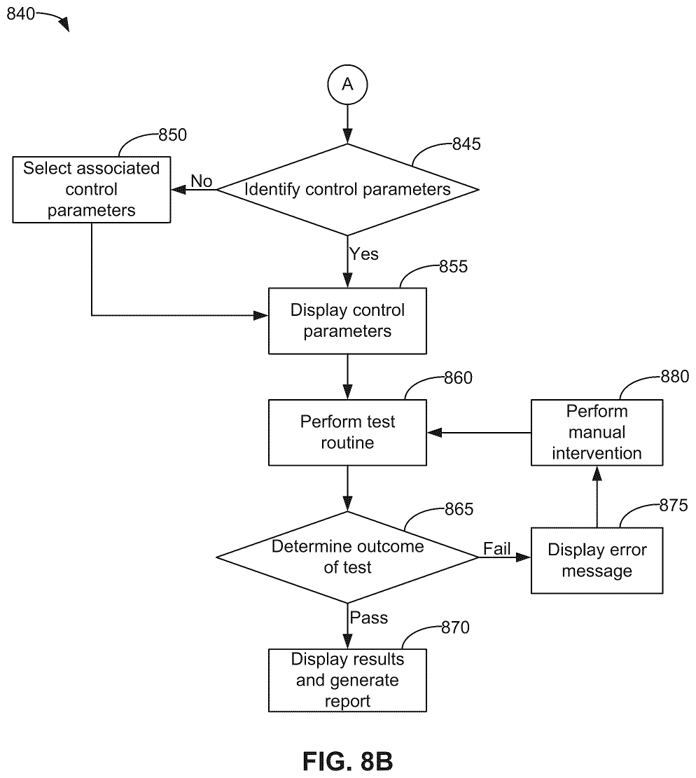

FIG. 8A depicts a flow diagram of a process 800 for remote testing of one or more pieces of building equipment, according to some embodiments. In some embodiments, at least one of the various systems described herein may perform at least one step and/or operation of the process 800. For example, the equipment testing system 705 may perform at least one step of the process 800. While several steps and/or operations of the process 800 may be described as being performed by a given system, device, and/or component, the process 800 and/or portions thereof may be performed by one or more systems, devices, and/or components. Additionally and/or alternatively, one or more steps of the process 800 may be combined, separated, omitted, skipped, repeated, replicated, or otherwise altered.

At step 805, a system is selected using a controller configuration tool (CCT). For example, the selection detector 725 may receive a selection of a system. In some embodiments, the CCT may be provided via a user interface and the user interface may include one or more selections. For example, the user interface may display a plurality of selectable elements (e.g., buttons, icons, etc.) that correspond to a plurality of pieces of building equipment. In some embodiments, the selection detector 725 may receive the selection as a result of an interaction with a user interface. For example, the user interface may transmit a signal to the selection detector 725 as a result of a button being pressed on the interface.

At step 810, an associated test case may be identified. For example, the evaluation identifier 730 may identify an evaluation that tests a performance of the given piece of building equipment selected in step 805. In some embodiments, the evaluation identifier 730 may identify the test case by retrieving and/or accessing information that is stored in the database 755. For example, the database 755 may include a list of test cases and the evaluation identifier 730 may identify a given test case based on the selected parameters. In some embodiments, the evaluation identifier 730 may successfully identify the associated test case based on an inclusion of the associated test case in the database 755. The process 800 may proceed to step 815 responsive to identification of an associated test case. In some embodiments, the evaluation identifier 730 cannot successfully identify the associated test case. For example, the evaluation identifier 730 may not detect or identify correlations between the selected parameter and test cases stored in the database 755. The process 800 may proceed to step 820 responsive to a determination that an associated test case was not identified. In some embodiments, the process 800 may terminate at step 820.

In some embodiments, at step 810, the evaluation identifier 730 may select a test case from a plurality of test cases. For example, the database 755 may include multiple associated test cases for the selected system and the evaluation identifier 730 may select the test case from the multiple test cases. In some embodiments, one or more test cases can be associated with a given piece of equipment. For example, a first test case and a second test case can be associated with a VAV. In some embodiments, the evaluation identifier 730 may determine aspects of the evaluation. For example, the evaluation identifier 730 may determine that a given evaluation includes testing a performance of a valve. To continue this example, the evaluation identifier 730 may identify the given evaluation as the evaluation to test the performance of the building equipment responsive to the valve (tested in the given evaluation) matching the valve that was selected in step 805.

At step 815, the test case may be displayed. For example, the interface 750 may display a user interface including the test case. As another example, the interface 750 may transmit signals that causes a user device to display a user interface including the test case. In some embodiments, the displayed test case includes information pertaining to the evaluation. For example, the interface 750 may display at least one of the various user interfaces described herein.

In some embodiments, the process 800 may return to step 805. For example, the interface 750 may update the user interface to display the CCT. In some embodiments, the interface 750 may display a user interface including an indication that no associated test case could be identified. For example, the user interface may display an error message on the user device to indicate that no associated test case could be identified.

At step 825, an associated test routine may be identified. For example, the routine module 735 may identify a routine to perform the evaluation identified at step 810. In some embodiments, the test case may include an equipment cycle (e.g., an equipment startup, an equipment shutdown, etc.) and the routine may include a set of actions to perform (e.g., control the equipment) to perform the equipment cycle. In some embodiments, the routine module may identify the routine by retrieving and/or utilizing information that is stored in the database 755. For example, given routines may be identified based on relationships and/or mappings between routines and the test cases. In some embodiments, the routine module 735 successfully identifies the associated test routine. The process 800 may proceed to step 830 responsive to an identification of an associated test routine. In some embodiments, the process 800 may proceed to step 835 responsive to a determination that no associated test routine was identified. The process 800 may terminate at step 835.

In some embodiments, the test routine identified in step 825 may be identified by determining that the set of actions correlate to the aspects of the test case identified at step 810. For example, a test routine may include controlling a valve to have the valve move from a closed position to an open position. To continue this example, the valve moving to the open position may indicate a performance of the valve with respect to a heating cycle. In some embodiments, the set of actions may be linked and/or associated to the aspects of the evaluation and test routine may be identified based on the association.

At step 830, the test routine may be displayed. For example, the interface 750 may display a user interface including the test routine. As another example, the interface 750 may transmit signals that cause a user device to display a user interface including the test routine. As another example, the user interface that is displaying the test case may be updated to include the test routine responsive to the routine module 735 identifying the test routine.

In some embodiments, the process 800 is terminated at this step. In some embodiments, the process 800 may return to step 805. For example, the interface 750 may update the user interface to display the CCT. In some embodiments, the interface 750 may display a user interface including an indication that no associated test routine could be identified. For example, the user interface may display an error message on the user device to indicate that no associated test routine could be identified.

FIG. 8B is a flow diagram of a process 840 for remote testing one or more pieces of building equipment, according to some embodiments. In some embodiments, at least one of the various systems described herein may perform at least one step and/or operation of the process 840. For example, the equipment testing system 705 may perform at least one step of the process 840. While several steps and/or operations of the process 840 are described as being performed by a given system, device, and/or component, the process 840 and/or portions thereof may be performed by one or more systems, devices, and/or components. In some embodiments, the process 840 may be included with and/or executed with the process 800.

At step 845, one or more control parameters may be identified. For example, the data retriever 740 may identify the one or more control parameters needed to perform the associated test routine identified in step 825. In one exemplary embodiment, the test routine may refer to and/or include testing a fan's startup cycle. The data retriever 740 may identify the control parameters based on one or more relationships included in the point mappings 760. In some embodiments, the data retriever 740 may identify the control parameters by determining relationships between the equipment setpoints and one or more aspects of the building. For example, an air filtration system may turn on responsive to a detection of a given indoor air quality value. To continue this example, the data retriever may identify the given indoor air quality value as a control parameter. In some embodiments, the data retriever 740 cannot successfully identify the one or more control parameters. In this case, the process 840 may proceed to step 850 to receive the one or more control parameters. In some embodiments, the data retriever 740 may successfully identify the one or more control parameters. In this case, the process 840 may proceed to step 855.

At step 850, one or more associated control parameters are selected. For example, the data retriever 740 could not successfully identify one or more control parameters for the test routine and proceeds to step 850 to receive the control parameters. In some embodiments, the one or more control parameters can be selected on a user interface. For example, the interface 750 may update the user interface to display a list of possible associated control parameters. To continue this example, the associated control parameters can be selected by selecting one or more selectable elements on the user interface that correspond to the possible associated control parameters.

At step 855, the one or more associated control parameters are displayed. For example, the one or more associated control parameters may be displayed via the user interface that includes the associated test case and the associated test routine. As another example, the interface 750 may transmit signals that cause a user device to display a user interface including the one or more associated control parameters. As another example, the user interface that is displaying the test case may be updated to include the one or more associated control parameters responsive to the data retriever 740 identifying the one or more associated control parameters.

At step 860, the associated test routine is performed. For example, the equipment tester 745 may transmit control signals that causes one or more pieces of building equipment to perform one or more actions. The one or more actions may be associated with the associated test routine identified at step 825. For example, the equipment tester 745 may cause one or more pieces of building equipment to perform a startup cycle.

At step 865, the outcome of the test is determined. For example, the equipment tester 745 may determine whether the test routine was passed/failed. In some embodiments, the equipment tester 745 may determine the outcome of the test by comparing parameters of the equipment to one or more parameters identified in the associated test case. In some embodiments, the equipment tester 745 may determine that the test routine was a pass responsive to the equipment performing one or more actions that were specified by the test routine. In this case, the process 840 may proceed to step 870. In some embodiments, the equipment tester 745 may determine that the test routine was a failure responsive to the equipment failing to perform one or more actions specified by the test routine. In this case, the process 840 may proceed to step 875.

At step 870, the results of the test are displayed. For example, the results of the test routine may be displayed via a user interface. In some embodiments, a report is also generated. For example, the user interface may display a report including information pertaining to the test case performed, test results, and remarks. In some embodiments, the interface 750 may display at least one of the various user interface described herein.

At step 875, an error message is displayed. For example, at step 865, the equipment tester 745 may determine that the test routine was a failure responsive to the equipment failing to perform one or more actions specified by the test routine. In some embodiments, an interface may be displayed including an indication that the test routine failed. For example, the interface 750 may update the user interface to include an error message with information pertaining to the failed test. In some embodiments, the error message may include an indication that a manual intervention needs to be performed. For example, the error message may include a list of instructions for manual intervention.

At step 880, a manual intervention is performed. For example, at step 865, the equipment tester 745 may determine that the test routine was a failure responsive to the equipment failing to perform one or more actions specified by the test routine. In some embodiments, an interface may be displayed including instructions for manual intervention of the associated equipment. Upon completion of the manual intervention, the process 840 may return to step 860 to repeat the performance of the test routine.

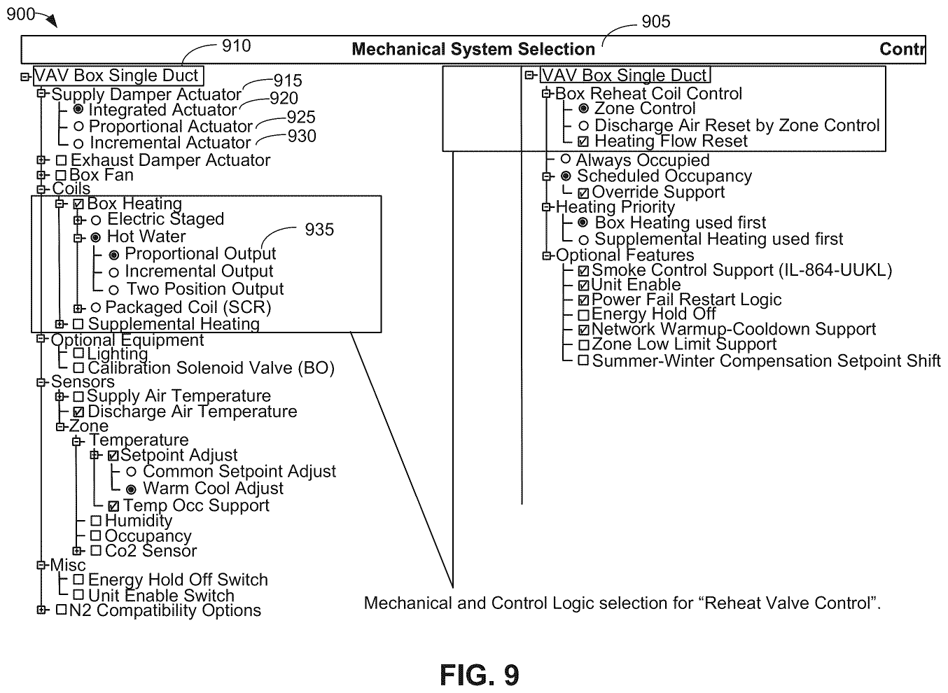

FIG. 9 depicts a user interface 900, according to some embodiments. In some embodiments, the user interface 900 may include the CCT described herein, shown as CCT 905. In some embodiments, the user interface 900 may be presented and/or displayed as a GUI. The user interface 900 may include one or more selectable elements. For example, the user interface 900 may include check boxes, option expand icons, option retract icons, and/or various other selectable elements. Elements 910, 915, 920, 925, 930, and 935 are each shown to correspond to selectable elements. In some embodiments, the user interface 900 may include at least one of the parameters described herein. For example, the user interface 900 may include parameters associated with one or more pieces of building equipment.

In some embodiments, the selection detector 725 may detect selections of at least one of the various selectable elements of the user interface 900. FIG. 9 depicts a non-limiting example of the parameters being associated with a VAV and/or one or more aspects thereof. For example, a selectable element 915 is shown to correspond to a supply damper actuator and the selectable element includes three options for a type of actuator. Elements 920, 925, and 935 are each shown to correspond to a selectable element for one of the three options for a type of actuator.

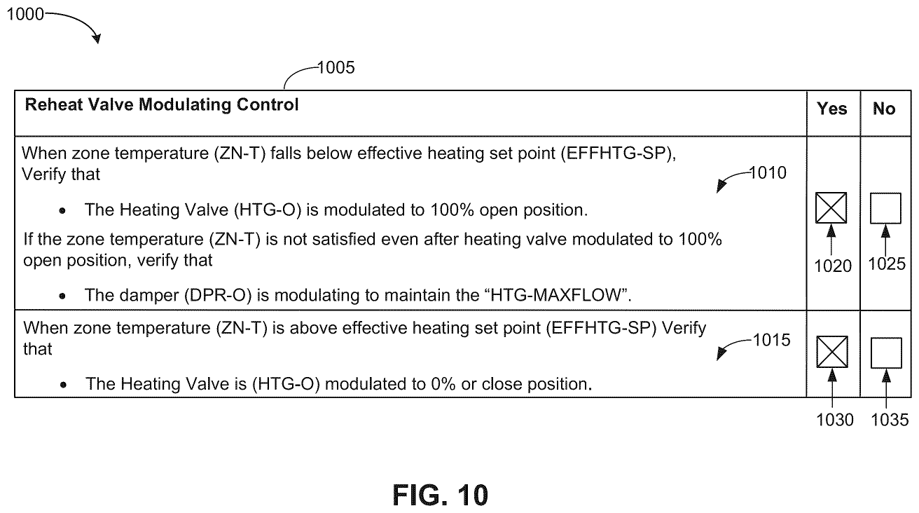

FIG. 10 depicts a user interface 1000, according to some embodiments. In some embodiments, the user interface 1000 may be generated, displayed, and/or presented responsive to the evaluation identifier 730 identifying an evaluation. In some embodiments, the user interface 1000 may include information pertaining to the evaluation. For example, the user interface 1000 may include a name of the evaluation 1005 as well as one or more testing criteria, shown as elements 1010 and 1015. In some embodiments, the user interface 1000 may include one or more selectable icons to accept and/or reject one or more aspects of the evaluation. Icons 1020, 1025, 1030, and 1035 are shown to correspond to the one or more selectable icons to accept and/or reject one or more aspects of the evaluation.

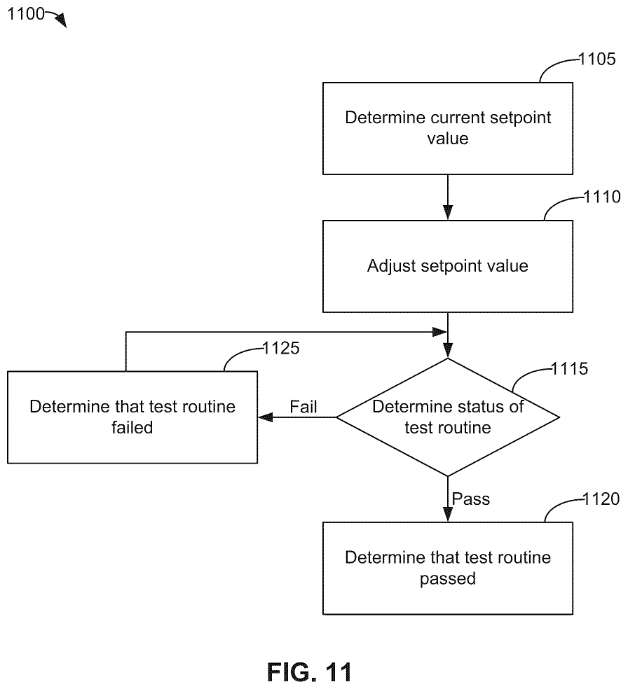

FIG. 11 depicts a flow diagram of a process 1100 for performing a test routine, according to some embodiments. In some embodiments, at least one of the various systems described herein may perform at least one step and/or operation of the process 1100. For example, the equipment testing system 705 may perform at least one step of the process 1100. While several steps and/or operations of the process 1100 are described as being performed by a given system, device, and/or component, the process 1100 and/or portions thereof may be performed by one or more systems, devices, and/or components.

At step 1105, a current setpoint value may be determined. For example, the data retriever 740 may determine a current setpoint value for a selected equipment parameter. In one exemplary embodiment, the current setpoint value determined at this step may be for an effective heating setpoint (EFFHTC-SP) for a piece of building equipment. For example, the data retriever 740 may determine a given temperature setpoint that may cause a piece of building equipment to begin a heating cycle. In some embodiments, the temperature setpoint may include at least one of the various control parameters described herein.

At step 1110, the setpoint value may be adjusted. For example, the equipment tester 745 may transmit signals to a piece of building equipment that causes the current setpoint value determined at step 1105 to change. In one exemplary embodiment, this step may include setting the EFFHTG-SP to a value that is greater than a zone temperature. For example, the equipment tester 745 may transmit signals to a piece of building equipment that causes the EFFHTG-SP value to change to a value greater than the zone temperature. In some embodiments, increasing the EFFHTG-SP to a value greater than the zone temperature may trigger a piece of building equipment to perform a reheat cycle. For example, one or more valves for a VAV may open to provide warm air to an air duct that services a zone corresponding to the zone temperature.

At step 1115, a status of a test routine may be determined. For example, the equipment tester 745 may determine if one or more actions to adjust the setpoint from 1110 was performed. In one exemplary embodiment, the equipment tester 745 may collect data to determine whether a heating valve (HTG-O) was moved from a closed position to an open position. The collected data may then provide an indication that the status of the test routine. For example, the collected data may indicate that the action was performed. In this instance, the process 1100 proceeds to step 1120. In another example, the equipment tester 745 may determine that the action has not been performed. In this instance, the process 1100 may proceed to step 1125.

At step 1120, a test routine may be determined to have been passed. For example, the equipment tester 745 may determine that the action was performed based on the data collected at step 1115. In one exemplary embodiment, the equipment tester 745 may determine whether a heating valve (HTG-O) was moved from a closed position to an open position. In this exemplary embodiment, the equipment tester 745 may determine that the action was performed responsive to a determination that the HTG-O event occurred (e.g., the heating valve opened).

At step 1125, a failure of a test routine may be determined. For example, the equipment tester 745 may determine that the action was not performed/was not performed correctly based on the data collected at step 1115. In one exemplary embodiment, the test routine may be considered a failure responsive to a determination that the HTG-O event did not occur. In some embodiments, the process 1100 may return to step 1115 upon determination that the test routine failed.

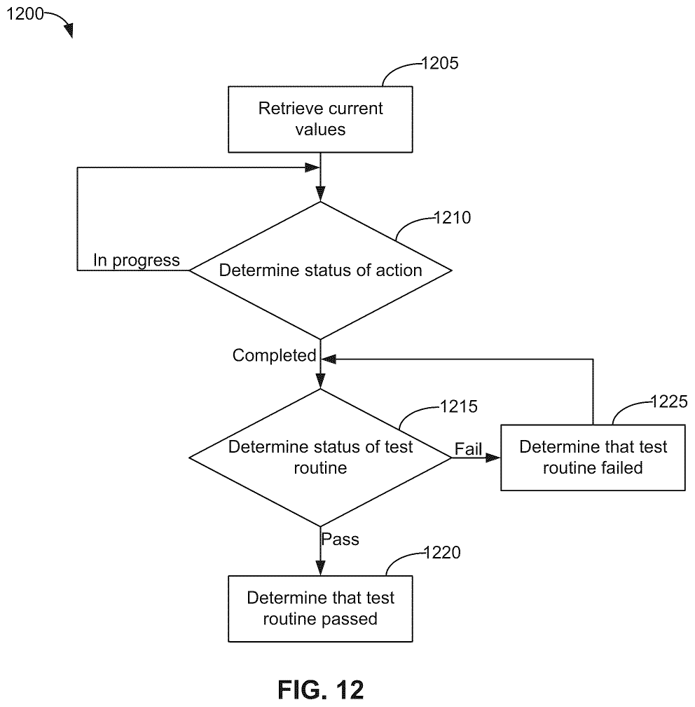

FIG. 12 depicts a flow diagram of a process 1200 for performing a test routine, according to some embodiments. In some embodiments, at least one of the various systems described herein may perform at least one step and/or operation of the process 1200. For example, the equipment testing system 705 may perform at least one step of the process 1200. While several steps and/or operations of the process 1200 are described as being performed by a given system, device, and/or component, the process 1200 and/or portions thereof may be performed by one or more systems, devices, and/or components.

At step 1205, one or more current values may be retrieved. For example, the equipment tester 745 may retrieve one or more control parameters from the equipment 775. In one exemplary embodiment, step 1205 may include reading a discharge air temperature (DA-T) and an HTG-O value. For example, the equipment tester may monitor a temperature of an air duct that services the zone and the equipment tester 745 may determine that the temperature of the air duct is increasing responsive to the heating valve moving to the open position.

At step 1210, a status of an action may be determined. For example, the equipment tester 745 may perform an action as a part of the test routine. At this step, the equipment tester 745 may retrieve data from the equipment 775 to determine that the action was been completed. For example, the equipment tester 745 may determine that the heating valve is in a fully open position. In this instance, the process 1200 may proceed to step 1210. In another example, the equipment tester 745 may determine that the heating valve has not moved to a fully open position. In this instance, the process 1200 may return to the beginning of step 1210 until the equipment tester 745 determines that the action has been completed.

At step 1215, a status of the test routine may be determined. For example, the equipment tester 745 may determine the status of the test routine responsive of the action performed at step 1210. In one exemplary embodiment, the test routine may collect data to determine whether a building setpoint has been adjusted and/or impacted responsive to the performance of the action in step 1210. The collected data may then provide an indication that the status of the test routine. For example, the collected data may indicate that the test routine has passed. In this instance, the process 1200 proceeds to step 1220. In another example, the equipment tester 745 may determine that the test routine has not passed. In this instance, the process 1200 repeats step 1215 until the test routine has passed.

At step 1220, a determination that the test routine passed may occur. For example, the equipment tester 745 may determine that the test routine passed based on the data collected at step 1215. In one exemplary embodiment, the equipment tester 745 may determine that the test routine passed responsive to a determination that a building setpoint has been adjusted and/or impacted responsive to performance of one or more actions by the equipment. In this exemplary embodiment, the equipment tester 745 may determine that the DA-T rising responsive to the heating valve being in a fully open position indicates that the equipment is functioning properly.

At step 1225, a determination that the test routine failed may occur. For example, the equipment tester 745 may determine that the test routine failed based on the data collected at step 1215. In one exemplary embodiment, the equipment tester 745 may determine that the DA-T failing to rise and/or rise to a level below a predetermined value may correspond to an equipment fault. In response to determining that the test routine failed, the process 1200 may return to step 1215 until the test routine passes.

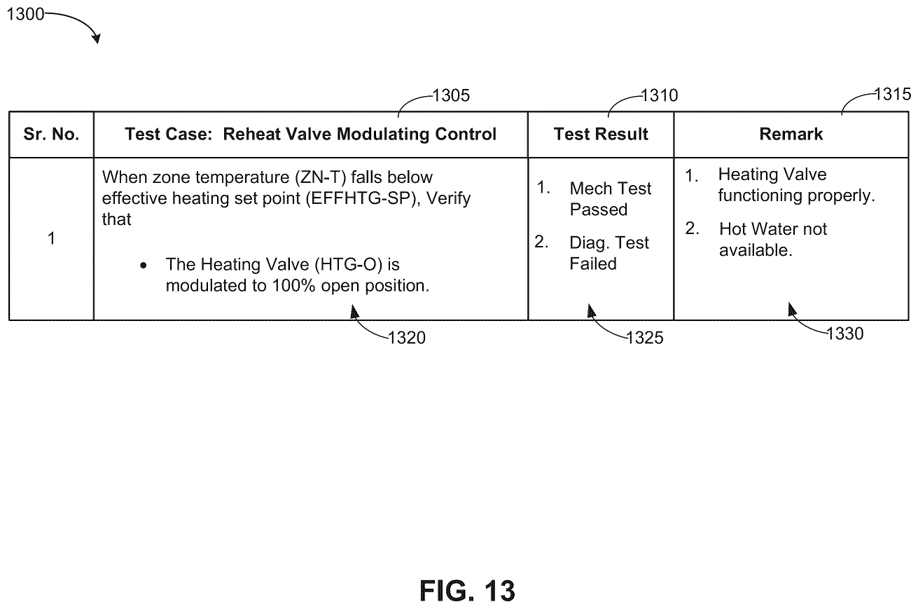

FIG. 13 depicts a user interface 1300, according to some embodiments. In some embodiments, the user interface 1300 may be generated responsive to completion of a test routine. For example, the user interface 1300 may be generated responsive to the equipment tester 745 determining the pieces of building equipment passed the test routine. For example, the user interface 1300 may include a name of the test case 1305. In some embodiments, the user interface 1300 may include a test result section 1310 and a remark section 1315. In some embodiments, the user interface 1300 may include an indication of the performance of the pieces of building equipment. In some embodiments, the user interface 1300 may include a textual summary 1320 of the evaluation that was performed, a textual summary 1325 of the performance of the one or more pieces of building equipment, and a textual summary 1330 explaining the performance of the one or more pieces of building equipment. In some embodiments, the textual summaries (e.g., the textual summary 1320, the textual summary 1325, the textual summary 1330, etc.) may refer to and/or include one or more text strings and/or strings (e.g., a collection of characters, a display of words, etc.).

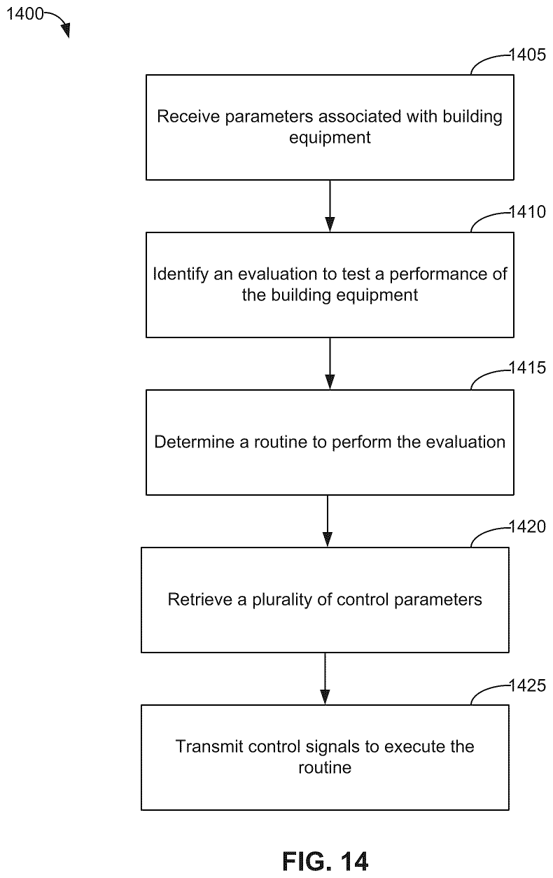

FIG. 14 is a flow diagram of a process 1400 for remote testing of building equipment, according to some embodiments. In some embodiments, at least one of the various systems described herein may perform at least one step and/or operation of the process 1400. For example, the equipment testing system 705 may perform at least one step of the process 1400. While several steps and/or operations of the process 1400 are described as being performed by a given system, device, and/or component, the process 1400 and/or portions thereof may be performed by one or more systems, devices, and/or components.

At step 1405, one or more parameters associated with building equipment may be received. For example, the selection detector 725 may receive a selection of the one or more parameters associated with the building equipment. As another example, a parameter relating to a heating valve in a building may be selected. In some embodiments, the selection may be received from a user interface. For example, a GUI on a device may display a plurality of parameters associated with the building equipment and the GUI may allow for the selection of one or more parameters with a selectable element (e.g., an icon, button, etc.). In some embodiments, the selection detector 725 may communicate with at least one component of the equipment testing system 705. For example, the selection detector 725 may communicate with the evaluation identifier 730. In some embodiments, the selection detector 725 may communicate with the evaluation identifier 730 responsive to the selection detector 725 receiving a selection.

At step 1410, an evaluation to test a performance of the building equipment may be identified. For example, the evaluation identifier 730 may identify one or more evaluations to test a piece of building equipment associated with the parameters received in step 1405. In some embodiments, the plurality of parameters may be associated with and/or linked to one or more evaluations. For example, the one or more parameters selected at step 1405 may relate to a heating valve. To continue this example, the evaluation identifier 730 may, at this step, identify an evaluation from a plurality of possible evaluations to test the performance of the heating valve.

At step 1415, a routine to perform the evaluation may be determined. For example, the routine module 735 may determine the routine 765 based on the evaluation identified at step 1410 and/or the parameters received at step 1405. In some embodiments, a given evaluation may include one or more routines (e.g., routines 765) and the routine module 735 may determine the routines based on the corresponding evaluation. For example, an evaluation identified at step 1410 may be related to evaluating the performance of a heating valve. To continue this example, the routine module 735 may determine a routine to perform the evaluation for the heating valve. In some embodiments, the routine 765 may include at least one of testing criteria, testing metrics, testing parameters, and/or testing elements. For example, the routine 765 to test the heating valve may include testing a relationship between a zone temperature and an effective heating set point.

At step 1420, a plurality of control parameters may be retrieved. For example, the routine module 735 may provide an indication of the determined routine from step 1415 to the data retriever 740. In some embodiments, the data retriever 740 may retrieve one or more parameters in response to receiving the determined routine. For example, the data retriever 740 may retrieve setpoints, values, parameters, and/or measurements. In some embodiments, the parameters may include equipment status (e.g., damper open, damper closed, fan on, fan off, lights on, lights off, etc.). In some embodiments, the parameters may include building metrics and/or building information, such as zone temperature readings, occupancy of the building, and/or various other information. For example, the data retriever may receive the determined routine from step 1415 for evaluating the heating valve. To continue this example, the data retriever 740 may retrieve the zone temperature and the effective heating set point temperature from the building equipment.

At step 1425, one or more control signals may be transmitted to execute the routine. For example, the equipment tester 745 may generate one or more control signals to transmit to the equipment 775 to execute the routine determined in step 1415. In some embodiments, the equipment tester 745 may generate equipment setpoints, equipment states changes, equipment actions, and/or equipment responses. In some embodiments, the equipment tester 745 may use control parameters to control the equipment. For example, the equipment tester 745 may use the effective heating set point temperature and the zone temperature retrieved in step 1420 to control the heating valve. In some embodiments, the interface 750 may transmit the one or more control signals to the equipment 775. For example, the interface 750 may transmit the one or more control signals to cause the equipment 775 to execute the routine.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures show a specific order of method steps, the order of the steps may differ from what is depicted. Also, two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps and decision steps.

What is claimed is:

1. A Building Management System (BMS) comprising one or more memory devices having instructions stored thereon that, when executed by one or more processors, cause the one or more processors to:
receive, via a user interface, a selection of a plurality of parameters associated with building equipment of a building, the plurality of parameters corresponding to one or more features of the building equipment;
identify, based on the plurality of parameters, an evaluation to test a performance of the building equipment with respect to the one or more features;
determine, responsive to identification of the evaluation, a routine to perform the evaluation, wherein the routine includes a plurality of actions that correspond to the evaluation;
retrieve, from a database, a plurality of control parameters configured to cause the building equipment to perform the plurality of actions; and
transmit, to the building equipment, control signals to cause the building equipment to execute the routine by adjusting values for the plurality of control parameters.

2. The BMS of claim 1, wherein a first control parameter of the plurality of control parameters includes a status parameter for the building equipment, and wherein a second control parameter of the plurality of control parameters includes a building parameter controllable by the building equipment.

3. The BMS of claim 1, wherein transmitting the control signals to execute the routine includes:
adjusting a building parameter from a first value to a second value to trigger a response from the building equipment;
monitoring the response of the building equipment; and
evaluating, based on the response of the building equipment, the performance of the building equipment with respect to the one or more features.

4. The BMS of claim 3, wherein the instructions further cause the one or more processors to:
update, responsive to completion of the evaluation, the user interface to include an indication of the performance of the building equipment;
wherein the indication of the performance of the building equipment includes:
a first string to indicate the evaluation that was performed; and
a second string to explain the performance of the building equipment.

5. The BMS of claim 1, wherein identifying the evaluation includes:
selecting the evaluation from a plurality of evaluations capable of testing the performance of the building equipment with respect to the one or more features.

6. The BMS of claim 5, wherein selecting the evaluation from the plurality of evaluations includes:
determining, based on the plurality of parameters, one or more aspects of the evaluation that correlate to the one or more features of the building equipment; and
selecting the evaluation from the plurality of evaluations responsive to determination of the one or more aspects.

7. The BMS of claim 1, wherein determining the routine to perform the evaluation includes:
selecting the routine from a plurality of routines capable of generating performance data sufficient to perform the evaluation.

8. The BMS of claim 7, wherein selecting the routine from the plurality of routines includes:
determining that the plurality of actions correlate to one or more aspects of the evaluation; and
selecting the routine from the plurality of routines responsive to determination of the correlation between the plurality of actions and the one or more aspects.

9. A method, comprising:
receiving, by one or more processing circuits, via a user interface, a selection of a plurality of parameters associated with building equipment of a building, the plurality of parameters corresponding to one or more features of the building equipment;
identifying, by the one or more processing circuits, based on the plurality of parameters, an evaluation to test a performance of the building equipment with respect to the one or more features;
determining, by the one or more processing circuits, responsive to identification of the evaluation, a routine to perform the evaluation, wherein the routine includes a plurality of actions that correspond to the evaluation;
retrieving, by the one or more processing circuits, from a database, a plurality of control parameters configured to cause the building equipment to perform the plurality of actions; and
transmitting, by the one or more processing circuits, to the building equipment, control signals to execute the routine by adjusting values for the plurality of control parameters.

10. The method of claim 9, wherein a first control parameter of the plurality of control parameters includes a status parameter for the building equipment, and wherein a second control parameter of the plurality of control parameters includes a building parameter controllable by the building equipment.

11. The method of claim 9, wherein transmitting the control signals to execute the routine includes:
adjusting, by the one or more processing circuits, a building parameter from a first value to a second value to trigger a response from the building equipment;
monitoring, by the one or more processing circuits, the response of the building equipment; and
evaluating, by the one or more processing circuits, based on the response of the building equipment, the performance of the building equipment with respect to the one or more features.

12. The method of claim 11, further comprising:
updating, by the one or more processing circuits, responsive to completion of the evaluation, the user interface to include an indication of the performance of the building equipment;
wherein the indication of the performance of the building equipment includes:
a first string to indicate the evaluation that was performed; and
a second string to explain the performance of the building equipment.

13. The method of claim 9, wherein identifying the evaluation includes:
selecting, by the one or more processing circuits, the evaluation from a plurality of evaluations capable of testing the performance of the building equipment with respect to the one or more features.

14. The method of claim 13, wherein selecting the evaluation from the plurality of evaluations includes:
determining, by the one or more processing circuits, based on the plurality of parameters, one or more aspects of the evaluation that correlate to the one or more features of the building equipment; and
selecting, by the one or more processing circuits, the evaluation from the plurality of evaluations responsive to determination of the one or more aspects.

15. The method of claim 9, wherein determining the routine to perform the evaluation includes:
selecting, by the one or more processing circuits, the routine from a plurality of routines capable of generating performance data sufficient to perform the evaluation.

16. The method of claim 15, wherein selecting the routine from the plurality of routines includes:
determining, by the one or more processing circuits, that the plurality of actions correlate to one or more aspects of the evaluation; and
selecting, by the one or more processing circuits, the routine from the plurality of routines responsive to determination of the correlation between the plurality of actions and the one or more aspects.

17. One or more non-transitory storage media storing instructions that, when executed by one or more processors, cause the one or more processors to perform operations comprising:
receiving, via a user interface, a selection of a plurality of parameters associated with building equipment of a building, the plurality of parameters corresponding to one or more features of the building equipment;
identifying, based on the plurality of parameters, an evaluation to test a performance of the building equipment with respect to the one or more features;
determining, responsive to identification of the evaluation, a routine to perform the evaluation, wherein the routine includes a plurality of actions that correspond to the evaluation;
retrieving, from a database, a plurality of control parameters configured to cause the building equipment to perform the plurality of actions; and
transmitting, to the building equipment, control signals to cause the building equipment to execute the routine by adjusting values for the plurality of control parameters.

18. The one or more non-transitory storage media of claim 17, wherein a first control parameter of the plurality of control parameters includes a status parameter for the building equipment, and wherein a second control parameter of the plurality of control parameters includes a building parameter controllable by the building equipment.

19. The one or more non-transitory storage media of claim 17, wherein transmitting the control signals to execute the routine includes:
adjusting a building parameter from a first value to a second value to trigger a response from the building equipment;
monitoring the response of the building equipment; and
evaluating, based on the response of the building equipment, the performance of the building equipment with respect to the one or more features.

20. The one or more non-transitory storage media of claim 19, wherein the instructions further cause the one or more processors to perform operations comprising:
updating, responsive to completion of the evaluation, the user interface to include an indication of the performance of the building equipment;
wherein the indication of the performance of the building equipment includes:
a first string to indicate the evaluation that was performed; and
a second string to explain the performance of the building equipment.
